(19) United States
(12) Patent Application Publication
(10) Pub. No.: US 2012/0246300 A1
(43) Pub. Date: Sep. 27, 2012

(54) ANALYZING APPARATUS, METHOD, SYSTEM, AND RECORDING MEDIUM OF PROGRAM

(75) Inventors: Atsushi KUBOTA, Kawasaki (JP); Ken Yokoyama, Kawasaki (JP); Hirokazu Iwakura, Kawasaki (JP); Junichi Higuchi, Kawasaki (JP)

(73) Assignee: FUJITSU LIMITED, Kawasaki-shi (JP)

(21) Appl. No.: 13/403,110

(22) Filed: Feb. 23, 2012

(30) Foreign Application Priority Data
Mar. 22, 2011 (JP) 2011-063399

(51) Int. Cl. G06F 11/34

(52) U.S. Cl. 709/224

(57) ABSTRACT

An analyzing apparatus including includes a memory and a processor that executes a procedure, the procedure including controlling the memory to store logs of communication between a first apparatus and a second apparatus, and logs of communication between the second apparatus and a third apparatus, and extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs stored in the memory.

### CROSS-REFERENCE TO RELATED APPLICATION

This application is based upon and claims the benefit of priority of the prior Japanese Patent Application No. 2011-63399, filed on Mar. 22, 2011, the entire contents of which are incorporated herein by reference.

### FIELD

The embodiments discussed herein are related to an analyzing apparatus, an analyzing program, an analyzing method, and a system.

### BACKGROUND

There has been a technique for analyzing the call relationship of the communication of a request-response in a system including an apparatus that transmits, in response to a received request, a request corresponding to the received request to another apparatus and further returns a response corresponding to a response received from another apparatus.

In the technique of the related art, when a model creation instruction is input, a transaction model satisfying the constraint condition of a call between servers is created on the basis of a message set selected in accordance with a selection criterion based on the possibility of a call relationship between processing operations. In addition, when an analysis instruction is input, the processing state of a transaction is analyzed on the basis of a protocol log meeting the transaction model.

In the above-mentioned technique of the related art, in order to associate the logs of communication, which have a call relationship, with each other, a preliminarily defined model is used. However, for example, owing to the specification change of the system or the like, performed after the model creation, a case occurs in which a request and a request called by the former request have not been defined in the preliminarily defined model. Therefore, it may be difficult to associate the logs of communication including the requests, respectively, with each other.

### SUMMARY

According to an aspect of the invention, an analyzing apparatus includes a memory and a processor that executes a procedure, the procedure including controlling the memory to store logs of communication between a first apparatus and a second apparatus, and logs of communication between the second apparatus and a third apparatus, and extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an entire configuration diagram of a system to which an analyzing apparatus according to a first embodiment is applied;

FIG. 2 is a diagram illustrating an example of an entire configuration diagram of a system to which an analyzing apparatus according to a second embodiment is applied;

FIG. 3 is a diagram illustrating a configuration of a capture server according to the second embodiment;

FIG. 4 is a diagram illustrating an example of a pair list;

FIG. 5 is a diagram illustrating an example of a relationship between a first pair and a second pair;

FIG. 6 is a diagram illustrating an example of a first number-of-times table;

FIG. 7 is a diagram illustrating an example of a second number-of-times table;

FIG. 8 is a diagram illustrating an example of a degree table;

FIG. 9 is a diagram illustrating an example of a probability table;

FIG. 10 is a diagram illustrating an example of a degree-of-importance table;

FIG. 11 is a diagram for explaining an example of a calculation method for the number of times the second pair has occurred between a request of the first pair and a response thereof, the calculation method being performed by a calculation unit;

FIG. 12 is a diagram for explaining an example of a calculation method for a degree, performed by the calculation unit;

FIG. 13 is a diagram for explaining an example of processing of an extraction unit;

FIG. 14 is a diagram illustrating an example of a child candidate list;

FIG. 15 is a diagram illustrating an example of a parent candidate list;

FIG. 16 is a diagram illustrating an example of a portion of combinations calculated by the extraction unit;

FIG. 17 is a diagram for explaining an example of a calculation method for a feature vector of each of combinations, performed by the extraction unit;

FIG. 18 is a diagram illustrating an example of the degree of similarity calculated with respect to each of combinations;

FIG. 19 is a diagram illustrating an example of a score calculated by the extraction unit;

FIG. 20 is a flowchart illustrating a procedure of learning processing according to the second embodiment;

FIG. 21 is a flowchart illustrating a procedure of extraction processing according to the second embodiment;

FIG. 22 is a diagram illustrating a configuration of a capture server according to a third embodiment;

FIG. 23 is a diagram for explaining an example of processing of the extraction unit;

FIG. 24 is a diagram illustrating an example of a child candidate list;

FIG. 25 is a diagram illustrating an example of a parent candidate list;

FIG. 26 is a diagram illustrating an example of a portion of combinations calculated by an extraction unit;

FIG. 27 is a diagram for explaining an example of a calculation method for a feature vector of each of combination, performed by the extraction unit;

FIG. 28 is a diagram illustrating an example of the degree of similarity calculated with respect to each of combinations;

FIG. 29 is a diagram illustrating an example of a score calculated by the extraction unit;

FIG. 30 is a flowchart illustrating a procedure of extraction processing according to the second embodiment; and

FIG. 31 is a diagram illustrating a computer executing an analyzing program.

### DESCRIPTION OF EMBODIMENTS

Preferred embodiments of the present technology will be explained with reference to accompanying drawings.

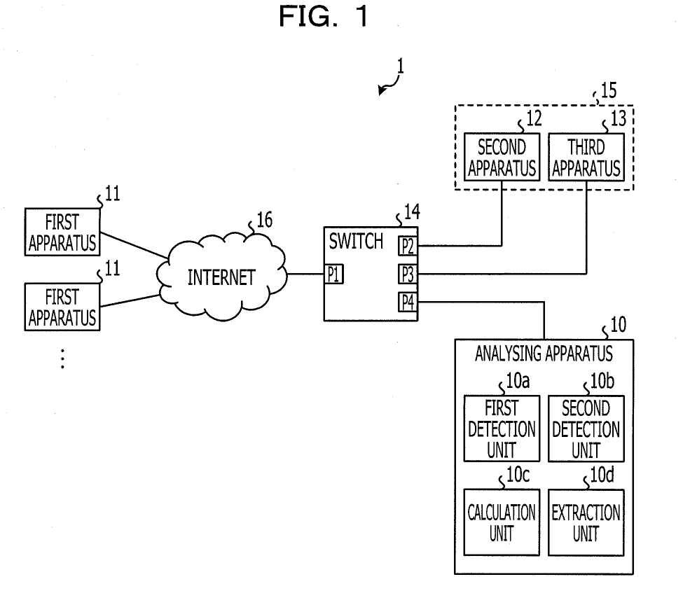

A system according to a first embodiment will be described. FIG. 1 is a diagram illustrating an example of the entire configuration diagram of a system to which an analyzing apparatus according to the first embodiment is applied. As illustrated in FIG. 1, a system 1 includes an analyzing apparatus 10, a first apparatus 11, a switch 14, and a service providing system 15. As an example of the system 1, a local area network (LAN) system in a company, a system in which orders for commercial products are accepted through Internet 16, or the like may be cited.

A first apparatus 11 is an apparatus for making a service request to the service providing system 15. For example, the first apparatus 11 is coupled to the Internet 16. On receiving the operation of a user, the first apparatus 11 transmits, to the Internet 16, the request message of a hypertext transfer protocol (HTTP), used for requesting a service. In this case, the first apparatus 11 transmits, to the Internet 16, a request message whose transmission destination is a second apparatus 12 described later. In addition, the first apparatus 11 receives a response from the second apparatus 12. For example, the first apparatus 11 receives the response message of an HTTP from the second apparatus 12. In addition, the first apparatus 11 displays the content of the response message in a browser. As an example of the first apparatus 11, a client terminal used by the user, or the like, may be cited. In addition, while, in the example of FIG. 1, a case is exemplified in which the number of the first apparatuses 11 is plural, an arbitrary number may be adopted as the number of the first apparatuses 11.

In the Internet 16, data is transmitted to an apparatus serving as a transmission destination. For example, in the Internet 16, a request message, which is a request message transmitted from the first apparatus 11 and whose transmission destination is the second apparatus 12, is transmitted to the switch 14 coupled to the second apparatus 12. In addition, in the Internet 16, a response message, which is a response message transmitted from the switch 14 and whose transmission destination is the first apparatus 11, is transmitted to the first apparatus 11.

The service providing system 15 provides a service in response to a request from the user. For example, the service providing system 15 includes the second apparatus 12 and a third apparatus 13.

In response to a request from the first apparatus 11, the second apparatus 12 transmit a request to the third apparatus 13. For example, in response to a request message from the first apparatus 11, which requests a service, the second apparatus 12 transmits the query of a structured query language (SQL) to the third apparatus 13.

In addition, in response to a response from the third apparatus 13, the second apparatus 12 transmits a response to the first apparatus 11. For example, in response to the response of an SQL from the third apparatus 13, the second apparatus 12 transmits the response message of an HTTP to the first apparatus 11. As an example of the second apparatus, a Web server or the like may be cited. In addition, while, in the example of FIG. 1, a case is exemplified in which the number of the second apparatuses 12 is one, the number of the second apparatuses 12 may be plural.

In response to a request from the second apparatus 12, the third apparatus 13 transmits a response to the second apparatus 12. For example, in response to the query of an SQL from the second apparatus 12, the third apparatus 13 accesses a DB not illustrated, and transmits the response of an SQL to the second apparatus 12. As an example of the third apparatus, a DB server or the like may be cited. In addition, while, in the example of FIG. 1, a case is exemplified in which the number of the third apparatuses 13 is one, the number of the third apparatuses 13 may be plural.

The switch 14 transmits and receives data between individual apparatuses including the first apparatus 11, the second apparatus 12, and the third apparatus 13, and transmits a copy of data flowing between the individual apparatuses, to the analyzing apparatus 10. In the example of FIG. 1, the port P1 of the switch 14 is coupled to the Internet 16 by physical or logical connection. In addition, in the example of FIG. 1, the port P2 of the switch 14 is coupled to the second apparatus 12. In addition, in the example of FIG. 1, the port P3 of the switch 14 is coupled to the third apparatus 13. In addition, in the example of FIG. 1, the port P4 of the switch 14 is coupled to the analyzing apparatus 10 by physical or logical connection. In the example of FIG. 1, when having received, from the first apparatus 11, a request message whose transmission destination is the second apparatus 12 through the Internet 16, the switch 14 transmits the received request message from the port P2 to the second apparatus 12. In addition, when having received, from the second apparatus 12, the query of an SQL, whose transmission destination is the third apparatus 13, the switch 14 transmits the received query of an SQL from the port P3 to the third apparatus 13. In addition, when having received, from the third apparatus 13, the response of an SQL, whose transmission destination is the second apparatus 12, the switch 14 transmits the received response of an SQL from the port P2 to the second apparatus 12. In addition, when having received, from the second apparatus 12, a response message whose transmission destination is the first apparatus 11, the switch 14 transmits the received response message from the port P1 to the first apparatus 11 through the Internet 16.

In addition, the switch 14 includes a so-called port mirroring function. For example, the switch 14 copies data going through the ports P1, P2, and P3, and transmits the copied data from the port P4 to the analyzing apparatus 10. Accordingly, it may be possible for the analyzing apparatus 10 to collect data flowing between the individual apparatuses including the first apparatus 11, the second apparatus 12, and the third apparatus 13. The switch 14 may correspond to a plurality of apparatuses, and be configured by an apparatus relaying communication between the first apparatus 11 and the second apparatus 12 and an apparatus relaying communication between the second apparatus 12 and the third apparatus 13, for example.

The analyzing apparatus 10 includes a first detection unit 10a, a second detection unit 10b, a calculation unit 10c, and an extraction unit 10d. On the basis of data flowing between the first apparatus 11 and the second apparatus 12, the first detection unit 10a detects a first pair of a request and a response between the first apparatus 11 and the second apparatus 12. As an example of the first pair, a request message, transmitted from the first apparatus 11 to the second apparatus 12, and a response message, which correspond to the request message and is transmitted from the second apparatus 12 to the first apparatus 11, may be cited. On the basis of data flowing between the second apparatus 12 and the third apparatus 13, the second detection unit 10b detects a second pair of a request and a response between the second apparatus 12 and the third apparatus 13. As an example of the second pair, the query of an SQL, transmitted from the second apparatus 12 to the third apparatus 13, and the response of an SQL, which corresponds to this query of an SQL and is transmitted from the third apparatus 13 to the second apparatus 12, may be cited. On the basis of the first pair detected in the first detection unit 10a and the second pair detected in the second detection unit 10b, the calculation unit 10c calculates the probability that the second pair exists between a request and a response in the first pair. On the basis of the probability calculated in the calculation unit 10c, the extraction unit 10d extracts a second pair corresponding to a given first pair. As an example of the given first pair, a first pair may be cited that is considered to be in a malfunctioning state in which a time from a request to a response has exceeded a given threshold value. In addition, a user such as the administrator of the system 1, or the like, may try to confirm the situation of such a given first pair.

As described above, the analyzing apparatus 10 according to the present embodiment calculates the probability that the second pair exists between a request and a response in the first pair, and, extracts a second pair corresponding to a given first pair on the basis of the calculated probability. In such a way as described above, on the basis of the probability, the analyzing apparatus 10 according to the present embodiment extracts the second pair corresponding to the given first pair without using a model preliminarily defining pieces of information associated with each other. Accordingly, even if a correspondence between a new first pair and a new second pair occurs owing to the specification change of the system or the like, it may be possible for the analyzing apparatus 10 according to the present embodiment to associate the new first pair with the new second pair. Accordingly, according to the analyzing apparatus 10 according to the present embodiment, it may be possible to more desirably associate pieces of relevant information with each other.

In addition, the analyzing apparatus 10 according to the present embodiment acquires the logs of communication in the system including the first apparatus 11, the second apparatus 12, and the third apparatus 13. In addition, from among the acquired logs, the analyzing apparatus 10 according to the present embodiment performs the following processing within a time range from a time when a request is transmitted from the first apparatus 11 to the second apparatus 12 to a time when a response corresponding to the request is transmitted from the second apparatus 12 to the first apparatus 11. Namely, the analyzing apparatus 10 extracts a log indicating a pair of a request and a response, communicated between the second apparatus 12 and the third apparatus 13. For example, within a given time range within which a request and a response are communicated more than once, the analyzing apparatus 10 according to the present embodiment calculates, with respect to each type, the probability that each of plural types of pairs of requests and responses, communicated between the second apparatus 12 and the third apparatus 13, has been communicated within a response time range of the request and response communicated more than once. In addition, with respect to a pair of a request and a response, communicated within a response time range relating to one of the request and response communicated more than once, the analyzing apparatus 10 according to the present embodiment generates a plurality of combination patterns of the types of pairs of requests and responses. In addition, the analyzing apparatus 10 according to the present embodiment selects one of the plural combination patterns on the basis of the degree of similarity with the calculated probability of each type. Accordingly, according to the analyzing apparatus 10 according to the present embodiment, it may be possible to sequentially associate communication logs having a call relationship with each other, with respect to the acquired communication logs.

Next, a second embodiment will be described. In the present embodiment, a case will be described in which a capture server is adopted as an example of the analyzing apparatus. In addition, in the present embodiment, a case will be described in which a client terminal is adopted as an example of the first apparatus. In addition, in the present embodiment, a case will be described in which a Web server is adopted as an example of the second apparatus. In addition, in the present embodiment, a case will be described in which a DB server is adopted as an example of the third apparatus.

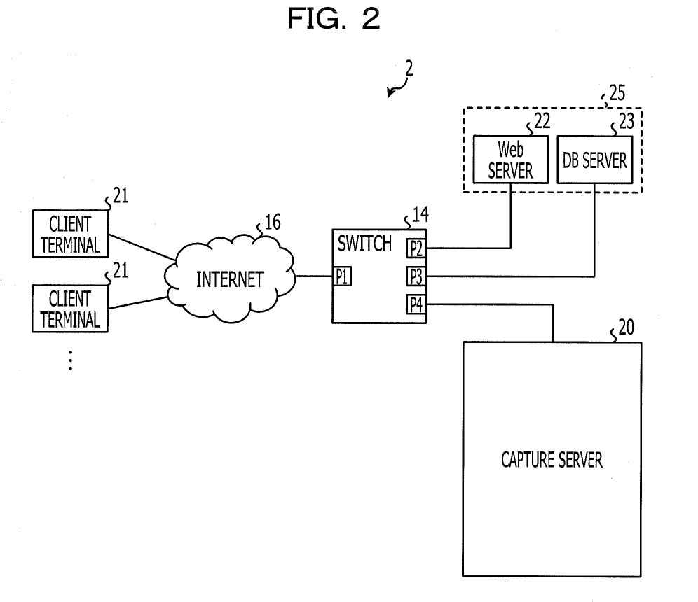

FIG. 2 is a diagram illustrating an example of the entire configuration diagram of a system to which the analyzing apparatus according to the second embodiment is applied. As illustrated in FIG. 2, a system 2 includes a capture server 20, a client terminal 21, a service providing system 25, and a switch 14. The system 25 includes a Web server 22 and a DB server 23. In addition, the system configuration of the second embodiment is the same as the system configuration of the first embodiment. In addition, in some cases, the same symbol will be assigned to the same configuration as that of the first embodiment and the description thereof will be omitted.

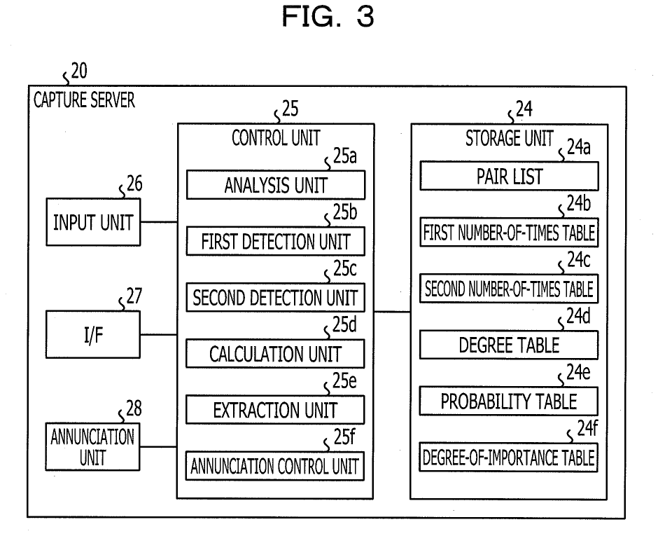

The capture server according to the second embodiment will be described. FIG. 3 is a diagram illustrating the configuration of the capture server according to the second embodiment. On the basis of data flowing between the client terminal 21 and the Web server 22, the capture server 20 according to the present embodiment detects a first pair of a request and a response between the client terminal 21 and the Web server 22. As an example of the first pair, a pair of a request message, transmitted from the client terminal 21 to the Web server 22, and a response message, which corresponds to this request message and is transmitted from the Web server 22 to the client terminal 21, may be cited. In addition, on the basis of data flowing between the Web server 22 and the DB server 23, the capture server 20 according to the present embodiment detects a second pair of a request and a response between the Web server 22 and the DB server 23. As an example of the second pair, the query of an SQL, transmitted from the Web server 22 to the DB server 23, and the response of an SQL, which corresponds to this query of an SQL and is transmitted from the DB server 23 to the Web server 22, may be cited. In addition, on the basis of the first pair and the second pair, the capture server 20 according to the present embodiment calculates the probability that the second pair exists between a request and a response in the first pair. In addition, on the basis of the probability, the capture server 20 according to the present embodiment extracts a second pair corresponding to a given first pair. As an example of the given first pair, a first pair may be cited that is considered to be in a malfunctioning state in which a time from a request to a response has exceeded a given threshold value. In addition, as an example of such a given first pair, a first pair may be cited the situation of which a user such as the administrator of the system 2, or the like, tries to confirm. As illustrated in FIG. 3, the capture server 20 includes an input unit 26, an Interface (I/F) 27, an annunciation unit 28, a storage unit 24, and a control unit 25.

The input unit 26 inputs information to the control unit 25. For example, on receiving an instruction from a user, the input unit 26 inputs, to the control unit 25, an instruction for executing extraction processing described later. Examples of information included in the instruction include a given first pair, the situation of which the user tries to confirm. As an example of the device of the input unit 26, a keyboard, a mouse, or the like may be cited.

The I/F 27 is a communication interface used for performing communication with the switch 14 and the control unit 25. For example, when having received a copy of a request message that is a copy of a request message transmitted from the switch 14 and a copy of a request message from the client terminal 21 to the Web server 22, the I/F 27 transmits the received copy of a request message to the control unit 25. In addition, when having received a copy of the query of an SQL that is a copy of the query of an SQL transmitted from the switch 14 and a copy of the query of an SQL from the Web server 22 to the DB server 23, the I/F 27 transmits the received copy of the query of an SQL to the control unit 25. In addition, when having received a copy of the response of an SQL that is a copy of the response of an SQL transmitted from the switch 14 and a copy of the response of an SQL from the DB server 23 to the Web server 22, the I/F 27 transmits the received copy of the response of an SQL to the control unit 25. In addition, when having received a copy of a response message that is a copy of a response message transmitted from the switch 14 and a copy of a response message from the Web server 22 to the client terminal 21, the I/F 27 performs the following processing. Namely, the I/F 27 transmits the received copy of a response message to the client terminal 21.

The annunciation unit 28 annunciates information. For example, the annunciation unit 28 annunciates a given number of correspondence relationships between first pairs and second pairs, whose scores are input by an annunciation control unit 25f described later and high. As the device of the annunciation unit 28, for example, a cathode ray tube (CRT), a liquid crystal display, or the like may be cited.

The storage unit 24 stores therein various kinds of programs to be executed in the control unit 25. In addition, the storage unit 24 stores therein a pair list 24a, a first number-of-times table 24b, a second number-of-times table 24c, a degree table 24d, a probability table 24e, and a degree-of-importance table 24f.

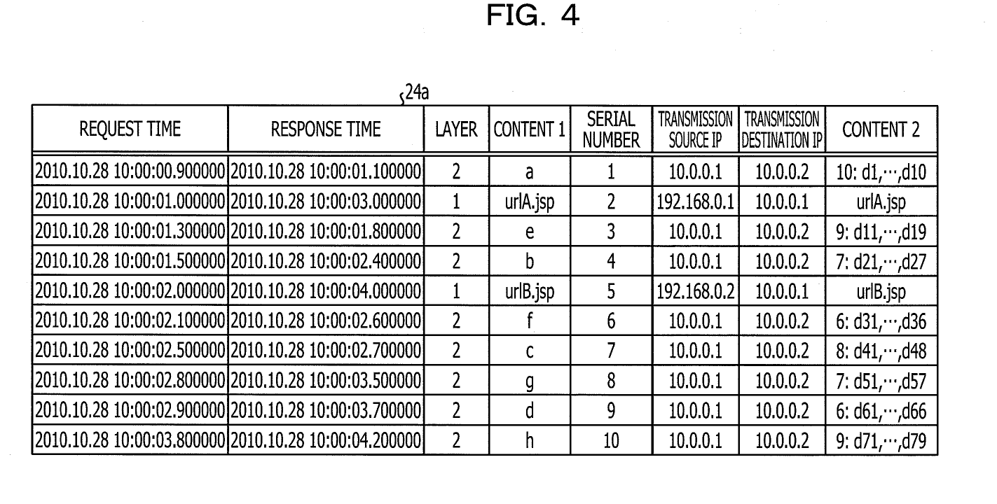

The pair list 24a is a table in which a pair of a request and a response correspond to the request are registered. In each record of the pair list 24a, each pair of a request and a response is registered by a first detection unit 25b and a second detection unit 25c, described later. FIG. 4 is a diagram illustrating an example of a pair list. The example of FIG. 4, indicates that, in the pair list 24a, the item of “request time” is included that is a time when the capture server 20 has received a request. In addition, the example of FIG. 4 indicates that, in the pair list 24a, the item of “response time” is included that is a time when the capture server 20 has received a response corresponding to a request. In addition, the example of FIG. 4 indicates that, in the pair list 24a, the item of “layer” is included that indicates whether the pair of a request and a response is a pair transmitted and received between the client terminal 21 and the Web server 22 or between the Web server 22 and the DB server 23. In addition, in the example of FIG. 4, when the pair of a request and a response is a pair transmitted and received between the client terminal 21 and the Web server 22, a first given value, for example, “1”, is registered in the “layer”. In addition, in the example of FIG. 4, when the pair of a request and a response is a pair transmitted and received between the Web server 22 and the DB server 23, a second given value, for example, “2”, is registered in the “layer”. Namely, in the item of the “layer”, information is registered that indicates whether the pair of a request and a response is the first pair or the second pair.

In addition, the example of FIG. 4 indicates that, in the pair list 24a, the item of “content 1” is included that is the content of a request. In addition, the example of FIG. 4 indicates that, in the pair list 24a, the item of “serial number” is included that is the serial number of the record of the pair list 24a. In addition, the example of FIG. 4 indicates that, in the pair list 24a, the item of “transmission source IP” is included that is the Internet Protocol (IP) address of the transmission source of a response. In addition, the example of FIG. 4 indicates that, in the pair list 24a, the item of “transmission destination IP” is included that is the IP address of the transmission destination of a response. In addition, the example of FIG. 4 indicates that, in the pair list 24a, the item of “content 2” is included that is the content of a response.

Here, in the example of FIG. 4, a record whose “serial number” is “1” indicates that a time when the capture server 20 has received the query of an SQL is “2010, Oct. 28, 10:00, 0.9 seconds”. In addition, in the example of FIG. 4, the record whose “serial number” is “1” indicates that a time when the capture server 20 has received the corresponding response of an SQL is “2010, Oct. 28, 10:00, 1.1 seconds”. In addition, in the example of FIG. 4, the record whose “serial number” is “1” indicates that the pair of the query of an SQL and the response of an SQL, registered in this record, is a pair transmitted and received between the Web server 22 and the DB server 23, namely, the second pair. In addition, in the example of FIG. 4, the record whose “serial number” is “1” indicates that the content of the query of an SQL is “a”. In addition, in the example of FIG. 4, the record whose “serial number” is “1” indicates that the IP address of the transmission source of the response of an SQL registered in the record is “10.0.0.1”. In addition, in the example of FIG. 4, the record whose “serial number” is “1” indicates that the IP address of the transmission destination of the response of an SQL registered in the record is “10.0.0.2”. In addition, in the example of FIG. 4, the record whose “serial number” is “1” indicates that the number of pieces of data included in the response of an SQL registered in the record is “10” and individual pieces of data are d1, . . . , d10.

In addition, in the example of FIG. 4, a record whose “serial number” is “2” indicates that a time when the capture server 20 has received a request message is “2010, Oct. 28, 10:01, 0.0 seconds”. In addition, in the example of FIG. 4, the record whose “serial number” is “2” indicates that a time when the capture server 20 has received the corresponding response message is “2010, Oct. 28, 10:00, 3.0 seconds”. In addition, in the example of FIG. 4, the record whose “serial number” is “2” indicates that the pair of the request message and the response message, registered in this record, is a pair transmitted and received between the client terminal 21 and the Web server 22, namely, the first pair. In addition, in the example of FIG. 4, the record whose “serial number” is “2” indicates that the content of the request message is “urlA.jsp”. In addition, in the example of FIG. 4, the record whose “serial number” is “2” indicates that the IP address of the transmission source of the response message registered in the record is “192.168.0.1”. In addition, in the example of FIG. 4, the record whose “serial number” is “2” indicates that the IP address of the transmission destination of the response message registered in the record is “10.0.0.1”. In addition, in the example of FIG. 4, the record whose “serial number” is “2” indicates that the content of data included in the response message is “urlA.jsp”. Since the registration contents of other records in the example of FIG. 4 are also similar to the above-mentioned contents, the descriptions thereof will be omitted.

In addition, information registered in the pair list 24a is not limited to the above-mentioned contents. Information available for associating the first pair and the second pair with each other may just be registered in the pair list 24a. For example, the information registered in the pair list 24a may just include the “request time”, the “response time”, the “layer”, and the “content 1”. In addition, an analysis unit 25a described later analyses data from the switch 14, and hence the information of each item registered in the pair list 24a is obtained.

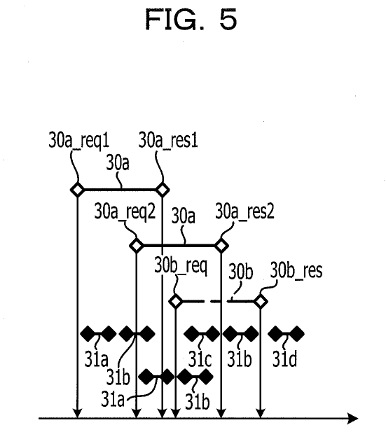

The first number-of-times table 24b is a table in which the number of times the first pair has emerged in data from the switch 14 is registered with respect to each type. In the first number-of-times table 24b, the number of times the first pair has emerged, calculated by a calculation unit 25d described later, is updated with respect to each type. FIG. 5 is a diagram illustrating an example of a relationship between the first pair and the second pair. In the example of FIG. 5, a horizontal axis indicates a time. The example of FIG. 5 indicates a case in which the first pairs of two types including two first pairs 30a and one first pair 30b have emerged in the data from the switch 14. In addition, in the following description, in some cases, the first pair 30a will be expressed as “pair 1”, and the first pair 30b will be expressed as “pair 2”.

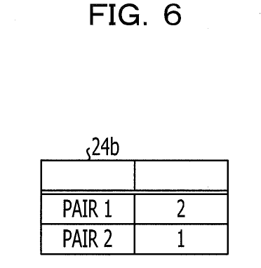

FIG. 6 is a diagram illustrating an example of the first number-of-times table. In a case in which the numbers of times relating to the “pair 1” and the “pair 2” in the first number-of-times table 24b are initial values “0”, when, as illustrated in the example of FIG. 5, two “pairs 1” and one “pair 2” have been detected by the first detection unit 25b described later, the following processing is performed. Namely, as illustrated in the example of FIG. 6, owing to the calculation unit 25d, in the first number-of-times table 24b, the number of times the “pair 1” has emerged is updated to “2” and the number of times the “pair 2” has emerged is updated to “1”.

The second number-of-times table 24c is a table in which the number of times the second pair has emerged within a time between the request and response of the first pair is registered. In the second number-of-times table 24c, the number of times the second pair has emerged within a time between the request and response of the first pair is updated by the calculation unit 25d. In the former example of FIG. 5, a case is illustrated in which second pairs 31a and 31b are included within a time period between the request 30a_req1 and the response 30a_resl of the first pair 30a that has emerged first. In addition, the term “included” here indicates that the occurrence times of the requests and responses of the second pairs are included within the time period between the request and the response of the first pair. In addition, in the example of FIG. 5, a case is illustrated in which second pairs 31a, 31b, and 31c are included within a time period between the request 30a_req2 and the response 30a_res2 of the first pair 30a that has emerged second. In addition, in the example of FIG. 5, a case is illustrated in which second pairs 31c and 31b are included within a time period between the request 30b_req and the response 30b_res of the first pair 30b. In addition, in the example of FIG. 5, a case is illustrated in which a second pair 31d emerges that is not included within any one of all the detected first pairs 30a and 30b. In addition, as an example of the case in which such a second pair 31d emerges, a case may be cited in which the second pair emerges owing to the batch processing of the DB server 23. In addition, in the following description, in some cases, the second pair 31a will be expressed as “SQL-a”, the second pair 31b will be expressed as “SQL-b”, the second pair 31c will be expressed as “SQL-c”, and the second pair 31d will be expressed as “SQL-d”.

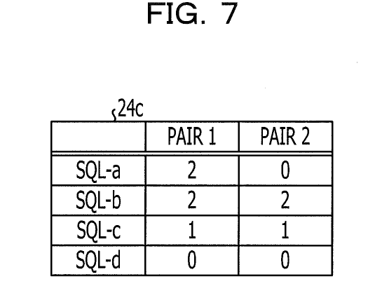

FIG. 7 is a diagram illustrating an example of the second number-of-times table. In a case in which the number of times each of the SQLs-a to d emerges with respect to each of the “pair 1” and the “pair 2” in the second number-of-times table 24c is an initial value “0”, when the second detection unit 25c detects the second pairs 31a to 31d as illustrated in the example of FIG. 5, the following processing is executed. Namely, as illustrated in the example of FIG. 7, the number of times the SQL-a has emerged with respect to the “pair 1” in the second number-of-times table 24c is updated to “2” by the calculation unit 25d. In addition, as illustrated in the example of FIG. 7, the number of times the SQL-b has emerged with respect to the “pair 1” in the second number-of-times table 24c is updated to “2” by the calculation unit 25d. In addition, as illustrated in the example of FIG. 7, the number of times the SQL-b has emerged with respect to the “pair 2” in the second number-of-times table 24c is updated to “2” by the calculation unit 25d. In addition, as illustrated in the example of FIG. 7, the number of times the SQL-c has emerged with respect to the “pair 1” in the second number-of-times table 24c is updated to “1” by the calculation unit 25d. In addition, as illustrated in the example of FIG. 7, the number of times the SQL-c has emerged with respect to the “pair 2” in the second number-of-times table 24c is updated to “1” by the calculation unit 25d.

The degree table 24d is a table in which the degree of a possibility to include the second pair is registered with respect to each type of the first pair. The degree registered in the degree table 24d is updated by the calculation unit 25d. In the former example of FIG. 5, a first pair that may include the second pair 31a that has emerged first is the first pair 30a that has emerged first. In addition, in the example of FIG. 5, a first pair that may include the second pair 31a that has emerged second is the first pair 30a that has emerged second. In the example of FIG. 5, a first pair that may include the second pair 31b that has emerged first is the first pair 30a that has emerged first. In addition, in the example of FIG. 5, first pairs that may include the second pair 31b that has emerged second are the first pair 30a and the first pair 30b, which have emerged second. In addition, in the example of FIG. 5, first pairs that may include the second pair 31c are the first pair 30a and the first pair 30b, which have emerged second. In the example of FIG. 5, a first pair that may include the second pair 31b that has emerged third is the first pair 30b. In addition, in the example of FIG. 5, no first pair exists that includes the second pair 31d. Here, in the calculation unit 25d described later, when, with respect to a certain second pair, the number of first pairs that may include this second pair is “N”, a value of “1/N” is added to the degree of each of the N first pairs for this second pair.

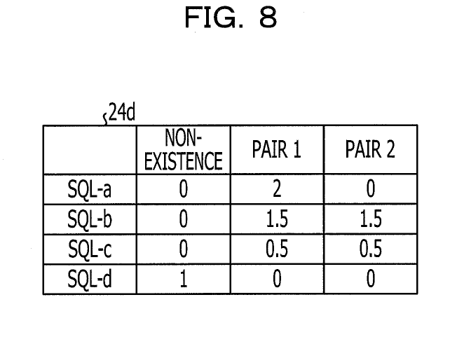

FIG. 8 is a diagram illustrating an example of a degree table. The degree of each item in the degree table 24d is an initial value “0” before learning processing described later is executed. In this case, as illustrated in the example of FIG. 5, when the second detection unit 25c has detected a second pair, the following processing is executed. Namely, as illustrated in the example of FIG. 8, the calculation unit 25d updates the degree of the “pair 1” for the SQL-a to “2”. In addition, as illustrated in the example of FIG. 8, the calculation unit 25d updates the degree of the “pair 1” for the SQL-b to “1.5”. In addition, as illustrated in the example of FIG. 8, the calculation unit 25d updates the degree of the “pair 2” for the SQL-b to “1.5”. In addition, as illustrated in the example of FIG. 8, the calculation unit 25d updates the degree of the “pair 1” for the SQL-c to “0.5”. In addition, as illustrated in the example of FIG. 8, the calculation unit 25d updates the degree of the “pair 2” for the SQL-c to “0.5”. In addition, as illustrated in the example of FIG. 8, when no first pair exists that includes the SQL-d, the calculation unit 25d updates, to “1”, the degree of the occurrence of the SQL-d due to the batch processing.

The probability table 24e is a table in which the probability that the first pair includes the second pair is registered. The probability registered in the probability table 24e is updated by the calculation unit 25d. In addition, by dividing each of the numbers of times the second pairs have emerged, registered in the second number-of-times table 24c, by each of the corresponding degrees registered in the degree table 24d, the calculation unit 25d described later calculates the probability that the first pair includes the second pair.

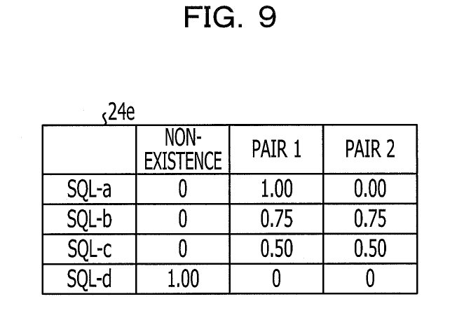

FIG. 9 is a diagram illustrating an example of a probability table. When the registration content of the second number-of-times table 24c corresponds to a content illustrated in FIG. 7 and the registration content of the degree table 24d corresponds to a content illustrated in FIG. 8, the calculation unit 25d registers the probability in the probability table 24e as follows. Namely, as illustrated in FIG. 9, it is registered in the probability table 24e that the probability that the SQL-a occurs owing to the batch processing is 0%. In addition, as illustrated in FIG. 9, it is registered in the probability table 24e that the probability that the SQL-b occurs owing to the batch processing is 0%. In addition, as illustrated in FIG. 9, it is registered in the probability table 24e that the probability that the SQL-c occurs owing to the batch processing is 0%. In addition, as illustrated in FIG. 9, it is registered in the probability table 24e that the probability that the SQL-d occurs owing to the batch processing is 100%. In addition, as illustrated in FIG. 9, it is registered in the probability table 24e that the probability that the “pair 1” includes the SQL-a is 100%. In addition, as illustrated in FIG. 9, it is registered in the probability table 24e that the probability that the “pair 1” includes the SQL-b is 75%. In addition, as illustrated in FIG. 9, it is registered in the probability table 24e that the probability that the “pair 1” includes the SQL-c is 50%. In addition, as illustrated in FIG. 9, it is registered in the probability table 24e that the probability that the “pair 1” includes the SQL-d is 0%. In addition, as illustrated in FIG. 9, it is registered in the probability table 24e that the probability that the “pair 2” includes the SQL-a is 0%. In addition, as illustrated in FIG. 9, it is registered in the probability table 24e that the probability that the “pair 2” includes the SQL-b is 75%. In addition, as illustrated in FIG. 9, it is registered in the probability table 24e that the probability that the “pair 2” includes the SQL-c is 50%. In addition, as illustrated in FIG. 9, it is registered in the probability table 24e that the probability that the “pair 2” includes the SQL-d is 0%.

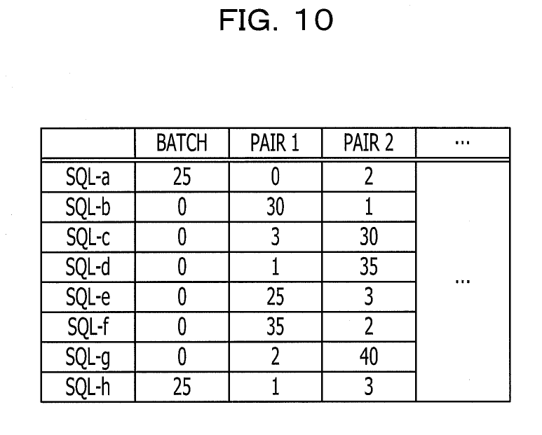

The degree-of-importance table 24f is a table in which the degree of importance is registered. Here, an example of the degree of importance will be described. For example, the degree of importance between a first pair and a second pair increases with an increase in the degree of a possibility that the first pair includes the second pair, and the degree of importance between a first pair and a second pair decreases with an increase in the number of the types of first pairs that may include the second pair. In addition, the degree of importance between a second pair and the “batch processing” increases with an increase in the degree of a possibility that the second pair occurs owing to the batch processing. In the degree-of-importance table 24f, an extraction unit 25e described later registers the degree of importance. FIG. 10 is a diagram illustrating an example of a degree-of-importance table. The example of FIG. 10 illustrates a case in which the degree of importance between the SQL-a and “batch processing” is “25”. In addition, the example of FIG. 10 illustrates a case in which the degree of importance between the SQL-a and the “pair 2” is “2”. In addition, the example of FIG. 10 illustrates a case in which the degree of importance between the SQL-b and the “pair 1” is “30”. In addition, the description of the other items of the degree-of-importance table 24f in the example of FIG. 10 will be omitted.

For example, the extraction unit 25e described later uses the degree of importance registered in the degree-of-importance table 24f, as the feature vector of the “batch processing”, the feature vector of the “pair 1”, the feature vector of the “pair 2”, . . . , and the feature vector of a pair N. The example of FIG. 10 illustrates a vector (25, 0, 0, 0, 0, 0, 0, 25) as the feature vector of the “batch processing”. In addition, the example of FIG. 10 illustrates a vector (0, 30, 3, 1, 25, 35, 2, 1) as the feature vector of the “pair 1”. In addition, the example of FIG. 10 illustrates a vector (2, 1, 30, 35, 3, 2, 40, 3) as the feature vector of the “pair 2”.

For example, the storage unit 24 is a semiconductor memory device such as a flash memory or the like, or a storage apparatus such as a hard disk, an optical disk, or the like. In addition, the storage unit 24 is not limited to the storage apparatuses of the above-mentioned types, and may also be a random access memory (RAM) or a read only memory (ROM).

Returning to the description of FIG. 3, the control unit 25 includes an internal memory for storing therein a program specifying various kinds of processing procedures and control data, and executes various kinds of processing operations. As illustrated in FIG. 3, the control unit 25 includes the analysis unit 25a, the first detection unit 25b, the second detection unit 25c, the calculation unit 25d, the extraction unit 25e, and the annunciation control unit 25f.

The analysis unit 25a analyses data. For example, the analysis unit 25a stores, in the storage unit 24, data that is transmitted from the switch 14 and whose amount corresponds to a given time, for example, data whose amount corresponds to 30 seconds, and repeatedly performs, on the stored data, processing for performing analysis described later, with respect to each given time.

An example of the analysis will be described that is performed by the analysis unit 25a. The analysis unit 25a analyses a copy of a request message transmitted from the client terminal 21 to the Web server 22, and acquires the content of a request included in the request message. For example, with respect to a request message such as “http://www.server.com/job/type.jsp”, the analysis unit 25a analyses that the request message is a request message for requesting a content, specified by the path notation of “/job/type.jsp”, from a server indicated by “www.server.com”. In addition, the analysis unit 25a analyses a copy of the query of an SQL transmitted from the Web server 22 to the DB server 23, and acquires the content of a query included in the query of an SQL. In addition, the analysis unit 25a acquires a time when a copy of the request message has been received. In addition, the analysis unit 25a acquires a time when a copy of the query of an SQL has been received.

In addition, the analysis unit 25a analyses a copy of a response message transmitted from the Web server 22 to the client terminal 21, and acquires the content of a response included in the response message. In addition, the analysis unit 25a analyses a copy of the response message, and acquires the IP address of a transmission source included in the response message. In addition, the analysis unit 25a analyses a copy of the response message, and acquires the IP address of a transmission destination included in the response message. In addition, the analysis unit 25a analyses a copy of the response of an SQL transmitted from the DB server 23 to the Web server 22, and acquires the content of a response included in the response of an SQL. In addition, the analysis unit 25a analyses a copy of the response of an SQL, and acquires the IP address of a transmission source included in the response of an SQL. In addition, the analysis unit 25a analyses a copy of the response of an SQL, and acquires the IP address of a transmission destination included in the response of an SQL. In addition, the analysis unit 25a acquires a time when a copy of the response message has been received. In addition, the analysis unit 25a acquires a time when a copy of the response of an SQL has been received.

The first detection unit 25b detects a first pair of a request and a response between the client terminal 21 and the Web server 22. For example, the first detection unit 25b associates a request message and a response message with each other, on the basis of the content of the request message and the content of the response message, analyzed by the analysis unit 25a. The term “associate” here is also called pairing, and indicates to associate a request message and a response message corresponding to the request message with each other.

In addition, the first detection unit 25b registers, in the pair list 24a, the first pair of the request message and the response message, associated with each other. In addition, as illustrated in FIG. 4, the first detection unit 25b registers, in the pair list 24a, a time when the capture server 20 has received a copy of the request message. In addition, as illustrated in FIG. 4, the first detection unit 25b registers, in the pair list 24a, a time when the capture server 20 has received a copy of the response message. In addition, as illustrated in FIG. 4, the first detection unit 25b registers, in the item of the “layer” of the pair list 24a, a first given value, for example, “1”, with respect to the first pair transmitted and received between the client terminal 21 and the Web server 22. In addition, as illustrated in FIG. 4, the first detection unit 25b registers the content of the request message in the “content 1” of the pair list 24a.

The second detection unit 25c detects a second pair of a request and a response between the Web server 22 and the DB server 23. For example, the second detection unit 25c associates the query of an SQL and the response of an SQL with each other, on the basis of the content of the query of an SQL and the content of the response of an SQL, analyzed by the analysis unit 25a. The term “associate” here indicates to associate a query of an SQL and a response of an SQL corresponding to the query of an SQL with each other.

In addition, the second detection unit 25c registers, in the pair list 24a, a second pair of the query of an SQL and the response of an SQL, associated with each other. In addition, as illustrated in FIG. 4, the second detection unit 25c registers, in the pair list 24a, a time when the capture server 20 has received a copy of the query of an SQL. In addition, as illustrated in FIG. 4, the second detection unit 25c registers, in the pair list 24a, a time when the capture server 20 has received a copy of the response of an SQL. In addition, as illustrated in FIG. 4, the second detection unit 25c registers, in the item of the “layer” of the pair list 24a, a second given value, for example, “2”, with respect to the second pair transmitted and received between the Web server 22 and the DB server 23. In addition, as illustrated in FIG. 4, the second detection unit 25c registers the content of the query of an SQL in the “content 2” of the pair list 24a. In addition, as illustrated in FIG. 4, the second detection unit 25c registers the IP address of the transmission source of the response of an SQL in the pair list 24a. In addition, as illustrated in FIG. 4, the second detection unit 25c registers the IP address of the transmission destination of the response of an SQL in the pair list 24a.

On the basis of the first pair detected in the first detection unit 25b and the second pair detected in the second detection unit 25c, the calculation unit 25d calculates the probability that the second pair exists between a request and a response in the first pair.

For example, first, the calculation unit 25d calculates the number of the first pairs detected by the first detection unit 25b, with respect to each type. In addition, the calculation unit 25d adds the calculated number of the first pairs to a corresponding item in the first number-of-times table 24b. Accordingly, the registration content of the first number-of-times table 24 is updated.

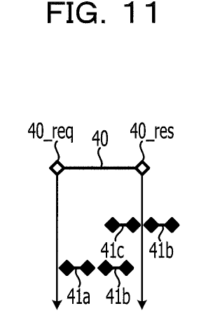

In addition, the calculation unit 25d calculates the number of times the second pair has emerged between a request of the first pair and a response thereof. FIG. 11 is a diagram for explaining an example of a calculation method for the number of times the second pair has occurred between a request of the first pair and a response thereof, the calculation method being performed by a calculation unit. The example of FIG. 11 illustrates a case in which one first pair 40, one second pair 41a, two second pairs 41b, and one second pair 41c occur. In the example of FIG. 11, the second pair 41a, the first of the second pairs 41b, and the second pair 41c are included in the first pair 40. In the example of FIG. 11, the calculation unit 25d calculates the number of times the second pair has emerged between the request 40_req and response 40_res of the first pair 40, as “1” with respect to the second pair 41a, as “1” with respect to the second pair 41b “1”, and as “1” with respect to the second pair 41c. In addition, with respect to each type, the calculation unit 25d adds the calculated number of times the second pair has emerged, to a corresponding item in the second number-of-times table 24c. Accordingly, the registration content of the second number-of-times table 24c is updated.

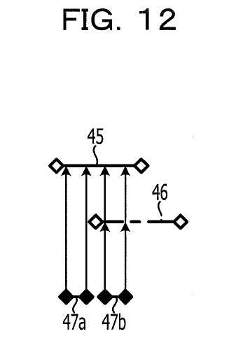

In addition, the calculation unit 25d calculates the degree of a possibility to include the second pair, with respect to each of the types of the first pairs. For example, when, with respect to a certain second pair, the number of first pairs that may include this second pair is “N”, the calculation unit 25d adds a value of “1/N” to the degree of each of the N first pairs for this second pair. FIG. 12 is a diagram for explaining an example of a calculation method for a degree, performed by the calculation unit. The example of FIG. 12 indicates a case in which a first pair 45, a first pair 46, a second pair 47a, and a second pair 47b occur. In the example of FIG. 12, while the first pair 45 may include the second pair 47a, the first pair 46 does not include the second pair 47a. In this case, the calculation unit 25d adds “1” to the degree of the first pair 45 for the second pair 47a in the degree table 24d. In addition, in the example of FIG. 12, the first pair 45 and first pair 46 may include the second pair 47a. In this case, the calculation unit 25d adds “0.5” to the degree of the first pair 45 for the second pair 47b in the degree table 24d. In addition, the calculation unit 25d adds “0.5” to the degree of the first pair 46 for the second pair 47b in the degree table 24d. In this way, the registration content of the degree table 24d is updated.

In addition, the calculation unit 25d calculates the probability that the first pair includes the second pair. For example, by dividing each of the numbers of times the second pairs have emerged, registered in the second number-of-times table 24c, by each of the corresponding degrees registered in the degree table 24d, the calculation unit 25d calculates the probability that the first pair includes the second pair. When the registration content of the second number-of-times table 24c corresponds to a content illustrated in FIG. 7 and the registration content of the degree table 24d corresponds to a content illustrated in FIG. 8, the calculation unit 25d calculates the probability as follows. Namely, the calculation unit 25d divides the number of times, “2”, the SQL-a has emerged with respect to the “pair 1” by the degree of a possibility, “2”, that the “pair 1” includes the SQL-a, thereby calculating a value of “1”. In this way, the calculation unit 25d calculates that the probability that the “pair 1” includes the SQL-a is 100%. In the same way, using the registration contents of the second number-of-times table 24c and the degree table 24d, the calculation unit 25d also calculates the probability that the other first pair includes the second pair. In addition, the calculation unit 25d registers the calculated probability in the probability table 24e. In this way, the registration content of the probability table 24e is updated.

The extraction unit 25e extracts a second pair corresponding to a given first pair on the basis of the calculated probability. For example, when an instruction for executing extraction processing has been input from the input unit 26, the extraction unit 25e performs processing described below. Namely, first, the extraction unit 25e calculates the degree of importance used for extracting a characteristic second pair included in the first pair.

Here, an example of a calculation method for the degree of importance performed in the extraction unit 25e will be described. The extraction unit 25e calculates the degree of importance I with respect to each second pair for the first pair, in accordance with the following Expression (1).

I=tf×log(N/df) Expression (1)

In this regard, however, the “tf” is the degree of a possibility that the first pair registered in the degree table 24d includes the second pair. In addition, the “N” is the sum of the numbers of times the first pairs registered in the first number-of-times table 24b have emerged. In addition, the “df” is the number of first pairs where the probabilities that the first pairs include a second pair are greater than “0”, the probabilities being registered in the probability table 24e. It may be possible for the extraction unit 25e to obtain such a number of the first pairs on the basis of the following processing. Namely, the types of first pairs are specified where the probabilities that the first pairs include a second pair, registered in the probability table 24e, are greater than “0”, and the sum of the numbers of first pairs of the specified types is calculated from among first pairs where the numbers of times the first pairs have emerged are registered in the first number-of-times table 24b.

In addition, in the degree-of-importance table 24f, the extraction unit 25e registers the degree of importance I calculated with respect to each second pair for a first pair, with respect to each second pair for the first pair.

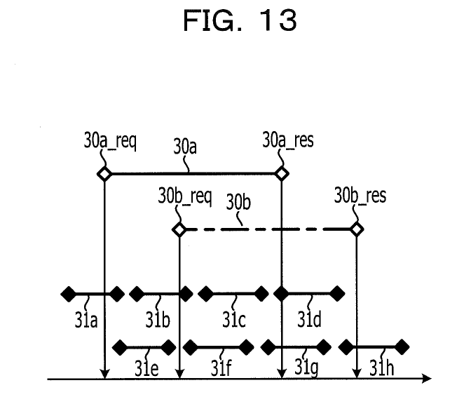

In addition, on the basis of the registration content of the pair list 24a, the extraction unit 25e extracts a second pair included in a first pair the situation of which the user tries to confirm, the first pair being included in the instruction for executing the extraction processing. FIG. 13 is a diagram for explaining an example of the processing of an extraction unit. In the example of FIG. 13, a horizontal axis indicates a time. The example of FIG. 13 illustrates a case where the first pairs of two types that include a first pair 30a and a first pair 30b have emerged. In addition, the example of FIG. 13 illustrates a case in which the second pairs of eight types including the second pairs 31a to 31h have emerged. The example of FIG. 13 illustrates a case in which the second pairs 31b, 31c, 31e, and 31f are included in the first pair 30a. In addition, the example of FIG. 13 illustrates a case in which the second pairs 31c, 31d, 31f, and 31g are included in the first pair 30b. In the following description, in some cases, the second pair 31e will be expressed as “SQL-e”, the second pair 31f will be expressed as “SQL-f”, the second pair 31g will be expressed as “SQL-g”, and the second pair 31h will be expressed as “SQL-h”.

For example, in the example of FIG. 13, when a given first pair included in an instruction for executing the extraction processing is the first pair 30a, the extraction unit 25e extracts the second pairs 31b, 31c, 31e, and 31f as second pairs included in the first pair 30a.

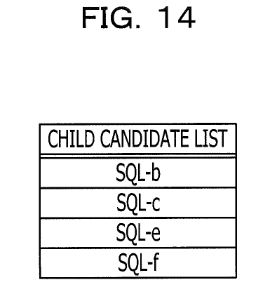

In addition, the extraction unit 25e registers the extracted second pairs in a “child candidate list”. FIG. 14 is a diagram illustrating an example of the child candidate list. The example of FIG. 14 illustrates a case in which the second pairs 31b, 31c, 31e, and 31f (SQLs-b, c, e, and f) are registered in the child candidate list.

In addition, on the basis of the registration content of the pair list 24a, the extraction unit 25e extracts a first pair that may include a second pair registered in the “child candidate list”. For example, in the example of FIG. 13, a first pair that may include the second pair 31b is the first pair 30a. In addition, in the example of FIG. 13, first pairs that may include the second pair 31c are the first pair 30a and the first pair 30b. In addition, in the example of FIG. 13, a first pair that may include the second pair 31e is the first pair 30a. In addition, in the example of FIG. 13, first pairs that may include the second pair 31f are the first pair 30a and the first pair 30b. In the example of FIG. 13, the extraction unit 25e extracts the first pair 30a and the first pair 30b, as first pairs that may include the second pairs registered in the “child candidate list”.

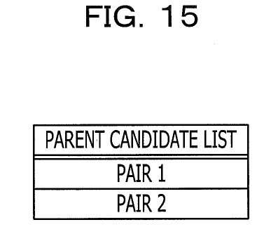

In addition, the extraction unit 25e registers the extracted first pairs in a “parent candidate list”. FIG. 15 is a diagram illustrating an example of the parent candidate list. The example of FIG. 15 illustrates a case in which the “pair 1” and the “pair 2” are registered in the parent candidate list.

In addition, the extraction unit 25e calculates feature vectors relating to the first pair registered in the parent candidate list and the “batch processing”. For example, the extraction unit 25e calculates the degree of importance of the first pair registered in the degree-of-importance table 24f and the degree of importance of “batch processing” as the feature vectors thereof, respectively. Here, a specific example will be cited and described. When, as illustrated in the example of FIG. 15, the “pair 1” and the “pair 2” are registered in the parent candidate list, and as illustrated in the example of FIG. 10, the degree of importance of each of the “batch processing”, the “pair 1”, and the “pair 2” is registered in the degree-of-importance table 24f, the extraction unit 25e performs the following processing. Namely, the extraction unit 25e calculates the feature vector (25, 0, 0, 0, 0, 0, 0, 25) of the “batch processing”. In addition, the extraction unit 25e calculates the feature vector (0, 30, 3, 1, 25, 35, 2, 1) of the “pair 1”. In addition, the extraction unit 25e calculates the feature vector (2, 1, 30, 35, 3, 2, 40, 3) of the “pair 2”.

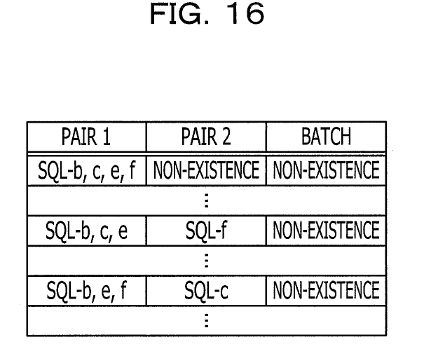

In addition, the extraction unit 25e calculates all the combinations of the second pairs registered in the child candidate list, the first pairs registered in the parent candidate list, and the “batch processing”. In this regard, however, the extraction unit 25e does not calculate the combination of a second pair and a first pair that may not include this second pair. An example of a calculation method for the combinations performed by the extraction unit 25e will be described. In the example of FIG. 13, the second pair 31b may be included in the first pair 30a. In addition, in the example of FIG. 13, the second pair 31b may occur owing to the batch processing. In addition, in the example of FIG. 13, the second pair 31c may be included in the first pair 30a. In addition, in the example of FIG. 13, the second pair 31c may be included in the first pair 30b. In addition, in the example of FIG. 13, the second pair 31c may occur owing to the batch processing. In addition, in the example of FIG. 13, the second pair 31e may be included in the first pair 30a. In addition, in the example of FIG. 13, the second pair 31e may occur owing to the batch processing. In addition, in the example of FIG. 13, the second pair 31f may be included in the first pair 30a. In addition, in the example of FIG. 13, the second pair 31f may be included in the first pair 30b. In addition, in the example of FIG. 13, the second pair 31f may occur owing to the batch processing. FIG. 16 is a diagram illustrating an example of a portion of the combinations calculated by the extraction unit. In the example of FIG. 13, the extraction unit 25e calculates a combination in which the SQLs-b, c, e, and f are associated with the “pair 1”, as one of the combinations, as illustrated in the example of FIG. 16. In addition, in the example of FIG. 13, the extraction unit 25e calculates a combination in which the SQLs-b, c, and e are associated with the “pair 1” and the SQL-f is associated with the “pair 2”, as one of the combinations, as illustrated in the example of FIG. 16. In addition, in the example of FIG. 13, the extraction unit 25e calculates a combination in which the SQLs-b, e, and f are associated with the “pair 1” and the SQL-c is associated with the “pair 2”, as one of the combinations, as illustrated in the example of FIG. 16. In addition to this, in the example of FIG. 13, the extraction unit 25e calculates the combination of the second pair and the first pair that may include the second pair, and the combination of the second pair and the “batch processing”.

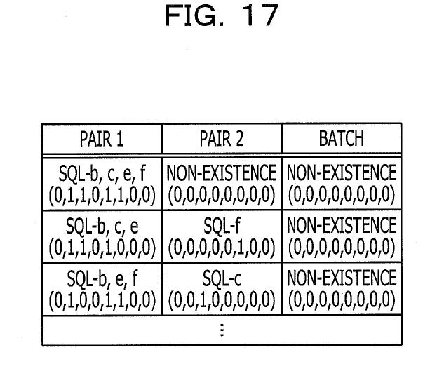

In addition, the extraction unit 25e calculates the feature vector of each of the calculated combinations. For example, with respect to each of the first pairs, the extraction unit 25e calculates a feature vector in which the element of a included second pair is “1” and the element of a second pair not included is “0”. Here, a specific example will be cited, and an example of a calculation method for the feature vector of a combination, performed by the extraction unit 25e, will be described. FIG. 17 is a diagram for explaining an example of the calculation method for a feature vector of each of combinations, performed by the extraction unit. For example, in the case of the combination of the first pair, the second pair, and the “batch processing”, illustrated in the example of FIG. 16, the extraction unit 25e performs processing described below, with respect to each combination. Namely, in the case of the combination in which the SQLs-b, c, e, and f are associated with the “pair 1”, the extraction unit 25e calculates a feature vector (0, 1, 1, 0, 1, 1, 0, 0) with respect to the “pair 1”, as illustrated in the example of FIG. 17. Here, the individual elements of the feature vector are (SQL-a, SQL-b, SQL-c, SQL-d, SQL-e, SQL-f, SQL-g, SQL-h). In addition to this, the extraction unit 25e calculates a feature vector (0, 0, 0, 0, 0, 0, 0, 0) with respect to the “pair 2”, as illustrated in the example of FIG. 17.

In addition, in the combination in which the SQLs-b, c, and e are associated with the “pair 1” and the SQL-f is associated with the “pair 2”, the extraction unit 25e calculates a feature vector (0, 1, 1, 0, 1, 0, 0, 0) with respect to the “pair 1”, as illustrated in the example of FIG. 17. In addition to this, the extraction unit 25e calculates a feature vector (0, 0, 0, 0, 0, 1, 0, 0) with respect to the “pair 2”, as illustrated in the example of FIG. 17.

In addition, in the combination in which the SQLs-b, e, and f are associated with the “pair 1” and the SQL-c is associated with the “pair 2”, the extraction unit 25e calculates a feature vector (0, 1, 0, 0, 1, 1, 0, 0) with respect to the “pair 1”, as illustrated in the example of FIG. 17. In addition to this, the extraction unit 25e calculates a feature vector (0, 0, 1, 0, 0, 0, 0, 0) with respect to the “pair 2”, as illustrated in the example of FIG. 17.

In addition, with respect to each of the combinations, the extraction unit 25e calculates the degree of similarity between each of the feature vector of the first pair and the feature vector of the “batch processing” and the calculated feature vector of the combination. In addition, while, as for a calculation method for the degree of similarity between vectors, there are various kinds of methods, an algorithm may be adopted that calculates the degree of cosine similarity, for example.

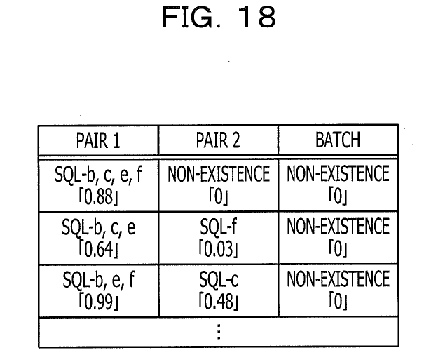

FIG. 18 is a diagram illustrating an example of the degree of similarity calculated with respect to each of the combinations. The example of FIG. 18 illustrates a case where the degree of similarity between a feature vector in a case in which the SQLs-b, c, e, and f are associated with the “pair 1” and the feature vector of the “pair 1” is “0.88”. In addition, the example of FIG. 18 illustrates a case where the degree of similarity between a feature vector in a case in which any one of the second pairs is not associated with the “pair 2” and the feature vector of the “pair 2” is “0”. In addition, the example of FIG. 18 illustrates a case where the degree of similarity between a feature vector in a case in which any one of the second pairs is not associated with the “batch processing” and the feature vector of the “batch processing” is “0”. In addition, the example of FIG. 18 illustrates a case where the degree of similarity between a feature vector in a case in which the SQLs-b, c, and e are associated with the “pair 1” and the feature vector of the “pair 1” is “0.64”. In addition, the example of FIG. 18 illustrates a case where the degree of similarity between a feature vector in a case in which the SQL-f is associated with the “pair 2” and the feature vector of the “pair 2” is “0.03”. In addition, the example of FIG. 18 illustrates a case where the degree of similarity between a feature vector in a case in which the SQLs-b, e, and f are associated with the “pair 1” and the feature vector of the “pair 1” is “0.99”. In addition, the example of FIG. 18 illustrates a case where the degree of similarity between a feature vector in a case in which the SQL-c is associated with the “pair 2” and the feature vector of the “pair 2” is “0.48”.

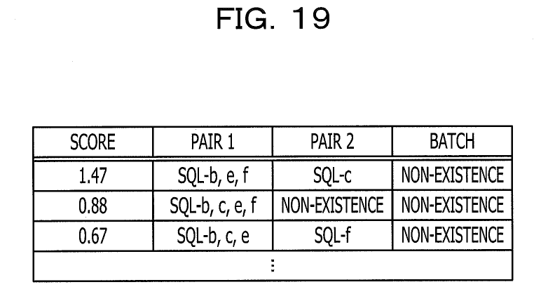

In addition, the extraction unit 25e calculates, as a score, the sum of the calculated degrees of similarity, with respect to the individual combinations. FIG. 19 is a diagram illustrating an example of the score calculated by the extraction unit. The example of FIG. 19 illustrates a case where the score of a combination in a case in which the SQLs-b, e, and f are associated with the “pair 1” and the SQL-c is associated with the “pair 2” is “1.47”. In addition, the example of FIG. 19 illustrates a case where the score of a combination in a case in which the SQLs-b, c, e, and f are associated with the “pair 1” is “0.88”. In addition, the example of FIG. 19 illustrates a case where the score of a combination in a case in which the SQLs-b, c, and e are associated with the “pair 1” and the SQL-f is associated with the “pair 2” is “0.67”.

Returning to the description of FIG. 3, the annunciation control unit 25f controls the annunciation unit 28 so as to annunciate a given number of correspondence relationships between first pairs and second pairs, whose scores are high, for example, whose scores are top three scores. Accordingly, for example, in the example of FIG. 19, the annunciation unit 28 annunciates a combination whose score is “1.47” and which is a combination in a case in which the SQLs-b, e, and f are associated with the “pair 1” and the SQL-c is associated with the “pair 2”. In addition, in the example of FIG. 19, the annunciation unit 28 annunciates a combination whose score is “0.88” and which is a combination in a case in which the SQLs-b, c, e, and f are associated with the “pair 1”. In addition, in the example of FIG. 19, the annunciation unit 28 annunciates a combination whose score is “0.67” and which is a combination in a case in which the SQLs-b, c, and e are associated with the “pair 1” and the SQL-f is associated with the “pair 2”.

The control unit 25 is an integrated circuit such as an application specific integrated circuit (ASIC), a field programmable gate array (FPGA), or the like, or an electronic circuit such as a central processing unit (CPU), a micro processing unit (MPU), or the like.

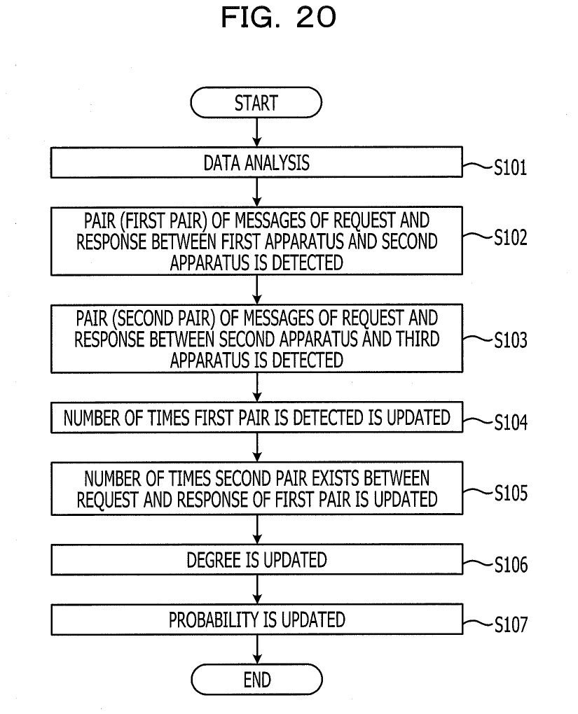

Next, the flow of the processing of the capture server 20 according to the present embodiment will be described. FIG. 20 is a flowchart illustrating the procedure of learning processing according to the second embodiment. As the execution timing of this learning processing, various cases may be considered. For example, since the capture server 20 stores, in the storage unit 24, data that is transmitted from the switch 14 and whose amount corresponds to a given time, for example, data whose amount corresponds to 30 seconds, it may be considered to repeatedly execute the learning processing on the stored data, with respect to each given time.

As illustrated in FIG. 20, the analysis unit 25a analyses the data that is stored in the storage unit 24 and whose amount corresponds to a given time (S101). The first detection unit 25b detects the first pair of a request and a response between the client terminal 21 and the Web server 22, and registers the first pair in the pair list 24a (S102). The second detection unit 25c detects the second pair of a request and a response between the Web server 22 and the DB server 23, and registers the second pair in the pair list 24a (S103).

The calculation unit 25d calculates the number of the detected first pairs with respect to each type, adds the calculated number of the first pairs to a corresponding item in the first number-of-times table 24b, and updates the registration content of the first number-of-times table 24 (S104). The calculation unit 25d calculates the number of times the second pair has emerged between a request of the first pair and a response thereof, adds the calculated number of times the second pair has emerged, to a corresponding item in the second number-of-times table 24c, with respect to each type, and updates the registration content of the second number-of-times table 24c (S105).

The calculation unit 25d calculates the degree of a possibility to include the second pair, with respect to each of the types of the first pairs, adds the calculated degree of a possibility to a corresponding item in the degree table 24d, and updates the registration content of the degree table 24d (S106). The calculation unit 25d calculates the probability that the first pair includes the second pair, registers the calculated probability in the probability table 24e, updates the registration content of the probability table 24e (S107), and terminates the processing.

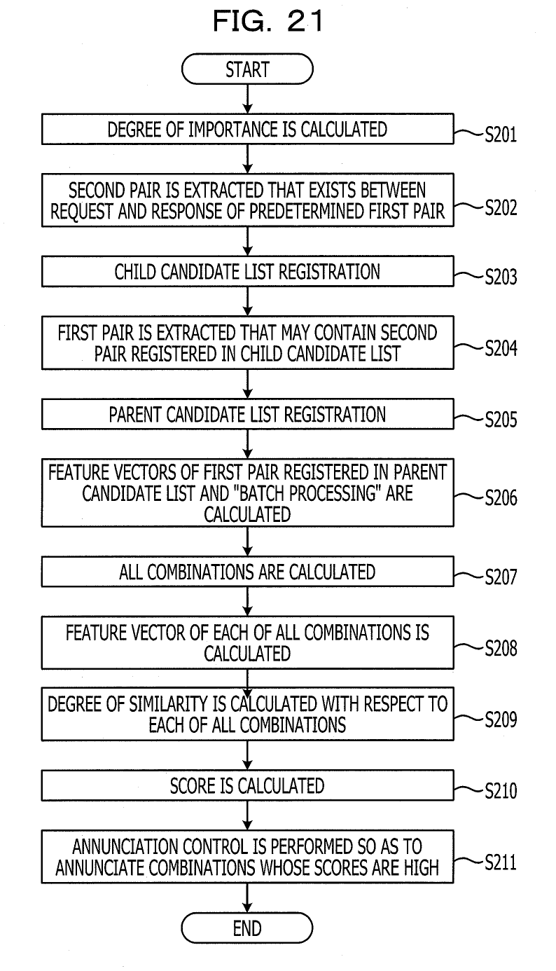

FIG. 21 is a flowchart illustrating the procedure of the extraction processing according to the second embodiment. As the execution timing of this extraction processing, various cases may be considered. For example, when an instruction for executing the extraction processing has been input from the input unit 26 to the control unit 25, the extraction processing is executed.

As illustrated in FIG. 21, the extraction unit 25e calculates the degree of importance used for extracting a characteristic second pair included in the first pair, and registers, in the degree-of-importance table 24f, the calculated degree of importance with respect to each second pair for the first pair (S201). On the basis of the registration content of the pair list 24a, the extraction unit 25e extracts a second pair included in a first pair the situation of which the user tries to confirm, the first pair being included in the instruction for executing the extraction processing (S202). The extraction unit 25e registers the extracted second pair in the “child candidate list” (S203).

On the basis of the registration content of the pair list 24a, the extraction unit 25e extracts a first pair that may include a second pair registered in the “child candidate list” (S204). The extraction unit 25e registers the extracted first pair in the “parent candidate list” (S205).

The extraction unit 25e calculates feature vectors relating to the first pair registered in the parent candidate list and the “batch processing” (S206). The extraction unit 25e calculates all the combinations of the second pairs registered in the child candidate list, the first pairs registered in the parent candidate list, and the “batch processing” (S207). The extraction unit 25e calculates the feature vector of each of all the calculated combinations (S208). With respect to each of all the combinations, the extraction unit 25e calculates the degree of similarity between each of the feature vector of the first pair and the feature vector of the “batch processing” and the calculated feature vector of the combination (S209). The extraction unit 25e calculates, as a score, the sum of the degrees of similarity calculated with respect to the individual combinations (S210). The annunciation control unit 25f controls the annunciation unit 28 so as to annunciate a given number of correspondence relationships between first pairs and second pairs, whose scores are high, for example, whose scores are top three scores (S211), and terminates the processing.

As described above, the capture server 20 according to the present embodiment calculates the probability that the second pair exists between a request and a response in the first pair, and extracts the second pair corresponding to a given first pair, on the basis of the calculated probability. In this way, on the basis of the probability, the capture server 20 according to the present embodiment extracts the second pair corresponding to the given first pair without using a model preliminarily defining pieces of information associated with each other. Accordingly, even if a correspondence between a new first pair and a new second pair occurs owing to the specification change of the system or the like, it may be possible for the capture server 20 according to the present embodiment to associate the new first pair and the new second pair with each other. Accordingly, according to the capture server 20 according to the present embodiment, it may be possible to more desirably associate pieces of relevant information with each other.

In addition, the capture server 20 according to the present embodiment acquires the logs of communication in the system including the first apparatus 11, the second apparatus 12, and the third apparatus 13. In addition, from among the acquired logs, the capture server 20 according to the present embodiment performs the following processing within a time range from a time when a request is transmitted from the first apparatus 11 to the second apparatus 12 to a time when a response corresponding to the request is transmitted from the second apparatus 12 to the first apparatus 11. Namely, the capture server 20 extracts a log indicating a pair of a request and a response, communicated between the second apparatus 12 and the third apparatus 13. For example, within a given time range within which a request and a response are communicated more than once, the capture server 20 according to the present embodiment calculates, with respect to each type, the probability that each of plural types of pairs of requests and responses, communicated between the second apparatus 12 and the third apparatus 13, has been communicated within a response time range of the request and response communicated more than once. In addition, with respect to a pair of a request and a response, communicated within a response time range relating to one of the request and response communicated more than once, the capture server 20 according to the present embodiment generates a plurality of combination patterns of the types of pairs of requests and responses. In addition, the capture server 20 according to the present embodiment selects one of the plural combination patterns on the basis of the degree of similarity with the calculated probability of each type. Accordingly, according to the capture server 20 according to the present embodiment, it may be possible to sequentially associate communication logs having a call relationship with each other, with respect to the acquired communication logs.

In addition, on the basis of the probability and the combination of second pairs that have existed between a request and a response in a given first pair included in an instruction for the extraction processing, the capture server 20 according to the present embodiment extracts a second pair corresponding to the given first pair. In this way, the capture server 20 according to the present embodiment associates the first pair and the second pair with each other on the basis of the combination of second pairs that have existed between a request and a response in the given first pair. Namely, when such associating is performed, the combination of second pairs is not considered that has existed between a request and a response in a first pair whose request or response has existed between a request and a response in the given first pair. Therefore, according to the capture server 20 according to the present embodiment, compared with a case in which such information is considered, it may be possible to associate the first pair and the second pair with each other using simple processing. In addition, within a given time range within which a request and a response are communicated more than once, the capture server 20 according to the present embodiment calculates, with respect to each type, the probability that each of plural types of pairs of requests and responses, communicated between the second apparatus 12 and the third apparatus 13, has been communicated within a response time range of the request and response communicated more than once. In addition, with respect to a pair of a request and a response, communicated within a response time range relating to one of the request and response communicated more than once, the capture server 20 according to the present embodiment generates a plurality of combination patterns of the types of pairs of requests and responses. In addition, the capture server 20 according to the present embodiment selects one of the plural combination patterns on the basis of the degree of similarity with the calculated probability of each type.

Incidentally, while, in the above-mentioned second embodiment, a case has been exemplified in which the first pair and the second pair is associated with each other on the basis of the combination of second pairs that have existed between a request and a response in a given first pair, the disclosed apparatus is not limited to the case. Therefore, in a third embodiment, a case will be described where the combination of second pairs is considered that has existed between a request and a response in a first pair whose request or response has existed between a request and a response in the given first pair.

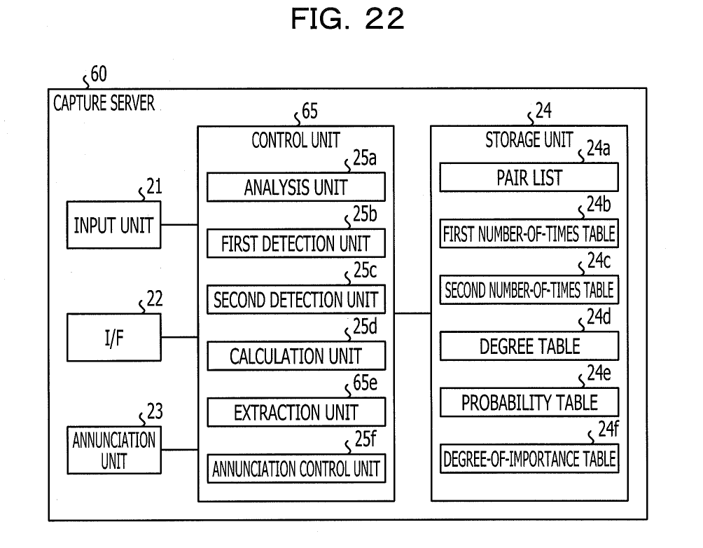

FIG. 22 is a diagram illustrating the configuration of a capture server according to the third embodiment. As illustrated in FIG. 22, a capture server 60 includes a control unit 65 in place of the control unit 25 according to the second embodiment. Such a control unit 65 differs from the control unit 25 in the second embodiment in that the control unit 65 includes an extraction unit 65e in place of the extraction unit 25e in the control unit 25 according to the second embodiment. In addition, hereinafter, the same symbol as in FIG. 2 will be assigned to each unit or each device fulfilling the same function as in the above-mentioned second embodiment, and the description thereof will be omitted.

The extraction unit 65e has the same function as that of the extraction unit 25e according to the second embodiment, and, in addition to this, performs processing described hereinafter.

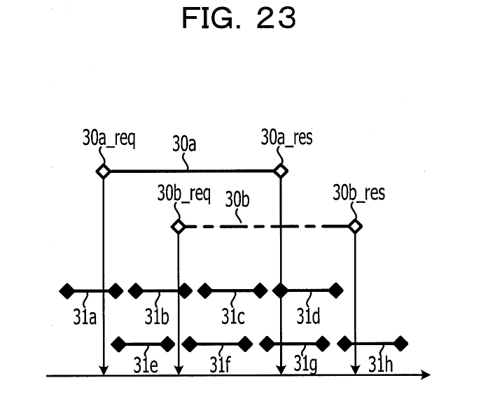

On the basis of the registration content of the pair list 24a, the extraction unit 65e extracts a second pair included in a first pair the situation of which the user tries to confirm, the first pair being included in the instruction for executing the extraction processing. In addition, on the basis of the registration content of the pair list 24a, the extraction unit 65e extracts a second pair that has existed between a request and a response in a first pair whose request or response has existed between a request and a response in a given first pair. In addition, it may be possible to limit the second pair extracted in such a way to a second pair whose request and response have been transmitted and received between the same apparatuses as apparatuses between which the request and the response of the given first pair have been transmitted and received. FIG. 23 is a diagram for explaining an example of the processing of the extraction unit. In the example of FIG. 23, a horizontal axis indicates a time. The example of FIG. 23 indicates a case in which the first pairs of two types including a first pair 30a and a first pair 30b have emerged. In addition, the example of FIG. 23 illustrates a case in which the second pairs of eight types including second pairs 31a to 31h have emerged. The example of FIG. 23 illustrates a case in which the second pairs 31b, 31c, 31e, and 31f are included in the first pair 30a. In addition, the example of FIG. 23 illustrates a case in which the second pairs 31c, 31d, 31f, and 31g are included in the first pair 30b.

For example, in the example of FIG. 23, when a given first pair included in an instruction for executing the extraction processing is the first pair 30a, the extraction unit 65e extracts the second pairs 31b, 31c, 31e, and 31f as second pairs included in the first pair 30a. In addition, the extraction unit 65e extracts the second pairs 31c, 31d, 31f, and 31g as second pairs included in the first pair 30b whose request or response has existed between a request 30a_req and a response 30a_res in the first pair 30a.

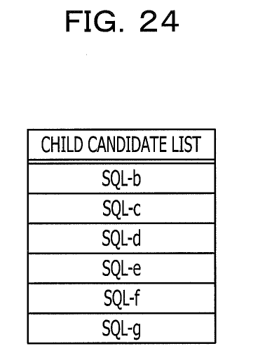

In addition, the extraction unit 65e registers the extracted second pairs in a “child candidate list”. FIG. 24 is a diagram illustrating an example of the child candidate list. The example of FIG. 24 illustrates a case in which the second pairs 31b, 31c, 31d, 31e, 31f, and 31g (SQLs-b, c, d, e, f, and g) are registered in the child candidate list.

In addition, on the basis of the registration content of the pair list 24a, the extraction unit 65e extracts a first pair that may include a second pair registered in the “child candidate list”. For example, in the example of FIG. 23, a first pair that may include the second pair 31b is the first pair 30a. In addition, in the example of FIG. 23, first pairs that may include the second pair 31c are the first pair 30a and the first pair 30b. In addition, in the example of FIG. 23, a first pair that may include the second pair 31d is the first pair 30b. In addition, in the example of FIG. 23, a first pair that may include the second pair 31e is the first pair 30a. In addition, in the example of FIG. 23, first pairs that may include the second pair 31f are the first pair 30a and the first pair 30b. In addition, in the example of FIG. 23, a first pair that may include the second pair 31g is the first pair 30b. In the example of FIG. 23, the extraction unit 65e extracts the first pair 30a and first pair 30b, as first pairs that may include the second pairs registered in the “child candidate list”.

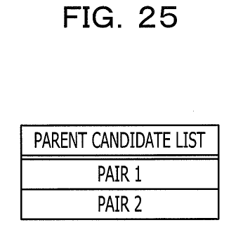

In addition, the extraction unit 65e registers the extracted first pairs in a “parent candidate list”. FIG. 25 is a diagram illustrating an example of the parent candidate list. The example of FIG. 25 illustrates a case in which the “pair 1” and the “pair 2” are registered in the parent candidate list.

In addition, in the same way as the extraction unit 25e according to the second embodiment, the extraction unit 65e calculates feature vectors relating to the first pair registered in the parent candidate list and the “batch processing”.

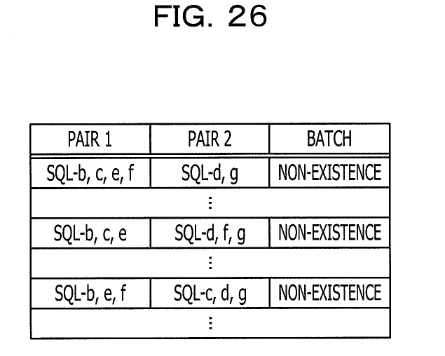

In addition, the extraction unit 65e calculates all the combinations of the second pairs registered in the child candidate list, the first pairs registered in the parent candidate list, and the “batch processing”. In this regard, however, the extraction unit 65e does not calculate the combination of a second pair and a first pair that may not include this second pair. An example of a calculation method for the combinations performed by the extraction unit 65e will be described. In the example of FIG. 23, the second pair 31b may be included in the first pair 30a. In addition, in the example of FIG. 23, the second pair 31b may occur owing to the batch processing. In addition, in the example of FIG. 23, the second pair 31c may be included in the first pair 30a. In addition, in the example of FIG. 23, the second pair 31c may be included in the first pair 30b. In addition, in the example of FIG. 23, the second pair 31c may occur owing to the batch processing. In addition, in the example of FIG. 23, the second pair 31d may be included in the first pair 30b. In addition, in the example of FIG. 23, the second pair 31d may occur owing to the batch processing. In addition, in the example of FIG. 23, the second pair 31e may be included in the first pair 30a. In addition, in the example of FIG. 23, the second pair 31e may occur owing to the batch processing. In addition, in the example of FIG. 23, the second pair 31f may be included in the first pair 30a. In addition, in the example of FIG. 23, the second pair 31f may be included in the first pair 30b. In addition, in the example of FIG. 23, the second pair 31f may occur owing to the batch processing. In addition, in the example of FIG. 23, the second pair 31g may be included in the first pair 30b. In addition, in the example of FIG. 23, the second pair 31g may occur owing to the batch processing. FIG. 26 is a diagram illustrating an example of a portion of combinations calculated by the extraction unit. In the example of FIG. 23, the extraction unit 65e calculates a combination in which the SQLs-b, c, e, and f are associated with the “pair 1” and the SQLs-d and g are associated with the “pair 2”, as one of the combinations, as illustrated in the example of FIG. 26. In addition, in the example of FIG. 23, the extraction unit 65e calculates a combination in which the SQLs-b, c, and e are associated with the “pair 1” and the SQLs-d, f, and g are associated with the “pair 2”, as one of the combinations, as illustrated in the example of FIG. 26. In addition, in the example of FIG. 23, the extraction unit 65e calculates a combination in which the SQLs-b, e, and f are associated with the “pair 1” and the SQLs-c, d, and g are associated with the “pair 2”, as one of the combinations, as illustrated in the example of FIG. 26. In addition to this, in the example of FIG. 23, the extraction unit 65e calculates the combination of the second pair and the first pair that may include the second pair, and the combination of the second pair and the “batch processing”.

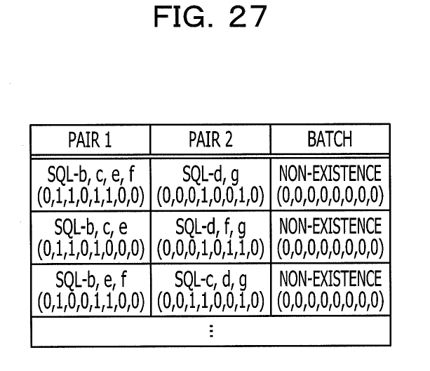

In addition, in the same as the extraction unit 25e according to the second embodiment, the extraction unit 65e calculates the feature vector of each of the calculated combinations. For example, with respect to each of the first pairs, the extraction unit 65e calculates a feature vector in which the element of a included second pair is “1” and the element of a second pair not included is “0”. Here, a specific example will be cited, and an example of a calculation method for the feature vector of a combination, performed by the extraction unit 65e, will be described. FIG. 27 is a diagram for explaining an example of the calculation method for a feature vector of each of combinations, performed by the extraction unit. For example, in the case of the combination of the first pair, the second pair, and the “batch processing”, illustrated in the example of FIG. 26, the extraction unit 65e performs processing described below, with respect to each combination. Namely, in the case of the combination in which the SQLs-b, c, e, and f are associated with the “pair 1”, the extraction unit 65e calculates a feature vector (0, 1, 1, 0, 1, 1, 0, 0) with respect to the “pair 1”, as illustrated in the example of FIG. 27. In addition to this, in the case of the combination in which the SQLs-d and g are associated with the “pair 2”, the extraction unit 65e calculates a feature vector (0, 0, 0, 1, 0, 0, 1, 0) with respect to the “pair 2”, as illustrated in the example of FIG. 27.

In addition, in the combination in which the SQLs-b, c, and e are associated with the “pair 1” and the SQLs-d, f, and d are associated with the “pair 2”, the extraction unit 65e calculates a feature vector (0, 1, 1, 0, 1, 0, 0, 0) with respect to the “pair 1”, as illustrated in the example of FIG. 27. In addition to this, the extraction unit 65e calculates a feature vector (0, 0, 0, 1, 0, 1, 1, 0) with respect to the “pair 2”, as illustrated in the example of FIG. 27.

In addition, in the combination in which the SQLs-b, e, and f are associated with the “pair 1” and the SQLs-c, d, and g are associated with the “pair 2”, the extraction unit 65e calculates a feature vector (0, 1, 0, 0, 1, 1, 0, 0) with respect to the “pair 1”, as illustrated in the example of FIG. 27. In addition to this, the extraction unit 65e calculates a feature vector (0, 0, 1, 1, 0, 0, 1, 0) with respect to the “pair 2”, as illustrated in the example of FIG. 27.

In addition, in the same way as the extraction unit 25e according to the second embodiment, with respect to each of the combinations, the extraction unit 65e calculates the degree of similarity between each of the feature vector of the first pair and the feature vector of the “batch processing” and the calculated feature vector of the combination.

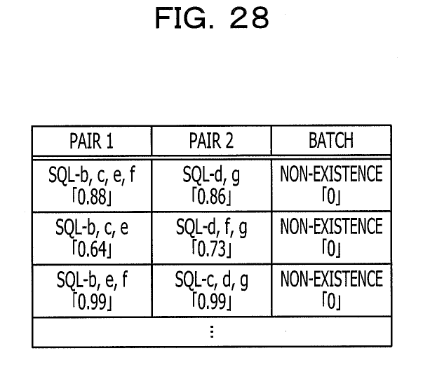

FIG. 28 is a diagram illustrating an example of the degree of similarity calculated with respect to each of the combinations. The example of FIG. 28 illustrates a case where the degree of similarity between a feature vector in a case in which the SQLs-b, c, e, and f are associated with the “pair 1” and the feature vector of the “pair 1” is “0.88”. In addition, the example of FIG. 28 illustrates a case where the degree of similarity between a feature vector in a case in which the SQLs-d and g are associated with the “pair 2” and the feature vector of the “pair 2” is “0.86”. In addition, the example of FIG. 28 illustrates a case where the degree of similarity between a feature vector in a case in which any one of the second pairs is not associated with the “batch processing” and the feature vector of the “batch processing” is “0”. In addition, the example of FIG. 28 illustrates a case where the degree of similarity between a feature vector in a case in which the SQLs-b, c, and e are associated with the “pair 1” and the feature vector of the “pair 1” is “0.64”. In addition, the example of FIG. 28 illustrates a case where the degree of similarity between a feature vector in a case in which the SQLs-d, f, and g are associated with the “pair 2” and the feature vector of the “pair 2” is “0.73”. In addition, the example of FIG. 28 illustrates a case where the degree of similarity between a feature vector in a case in which the SQLs-b, e, and f are associated with the “pair 1” and the feature vector of the “pair 1” is “0.99”. In addition, the example of FIG. 28 illustrates a case where the degree of similarity between a feature vector in a case in which the SQLs-c, d, and g are associated with the “pair 2” and the feature vector of the “pair 2” is “0.99”. In this way, the combination of second pairs is considered that has existed between a request and a response in a first pair whose request or response has existed between a request and a response in a given first pair, and a feature vector is calculated. Therefore, it may be possible for the accuracy of association to be further increased.

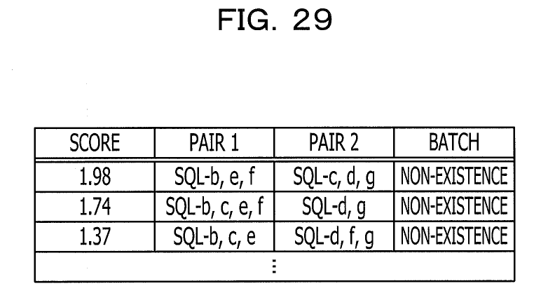

In addition, the extraction unit 65e calculates, as a score, the sum of the calculated degrees of similarity, with respect to the individual combinations. FIG. 29 is a diagram illustrating an example of the score calculated by the extraction unit. The example of FIG. 29 illustrates a case where the score of a combination in a case in which the SQLs-b, e, and f are associated with the “pair 1” and the SQLs-c, d, and g are associated with the “pair 2” is “1.98”. In addition, the example of FIG. 29 illustrates a case where the score of a combination in a case in which the SQLs-b, c, e, and f are associated with the “pair 1” and the SQLs-d and g are associated with the “pair 2” is “1.74”. In addition, the example of FIG. 29 illustrates a case where the score of a combination in a case in which the SQLs-b, c, and e are associated with the “pair 1” and the SQLs-d, f, and g are associated with the “pair 2” is “1.37”. On the basis of the scores, it may also be understood that, by considering the combination of second pairs that have existed between a request and a response in a first pair whose request or response has existed between a request and a response in a given first pair, it may be possible for the accuracy of association to be further increased.

The control unit 65 is an integrated circuit such as an application specific integrated circuit (ASIC), a field programmable gate array (FPGA), or the like, or an electronic circuit such as a central processing unit (CPU), a micro processing unit (MPU), or the like.

Next, the flow of the processing of the capture server 60 according to the present embodiment will be described. In addition, since learning processing according to the present embodiment is the same as the learning processing according to the second embodiment, the description thereof will be omitted.

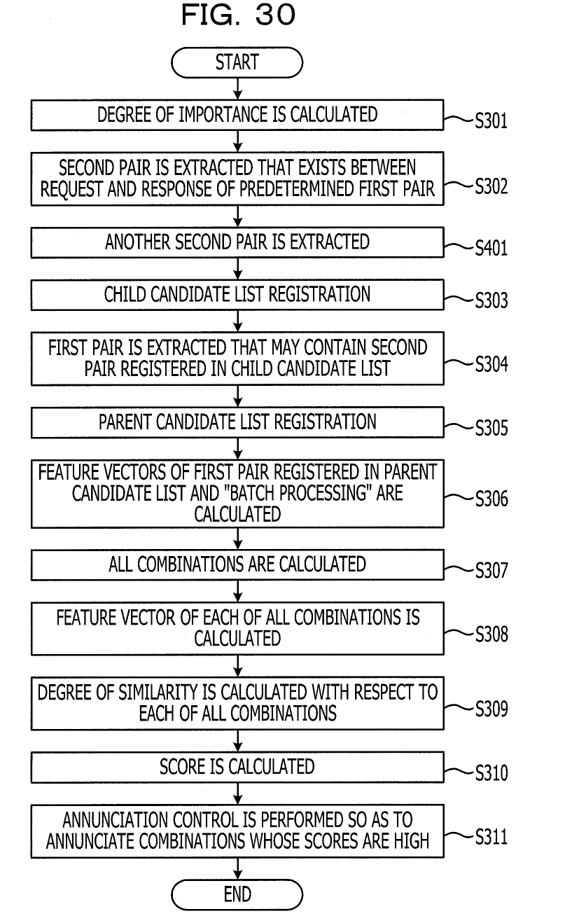

FIG. 30 is a flowchart illustrating the procedure of the extraction processing according to the second embodiment. As the execution timing of this extraction processing, various cases may be considered. For example, when an instruction for executing the extraction processing is input from the input unit 26 to the control unit 25, the extraction processing is executed. In addition, since the processing operations in S301 to S311 are the same as the processing operations in S201 to S211 in the extraction processing according to the second embodiment, respectively, the descriptions thereof will be omitted.

As illustrated in FIG. 30, the extraction unit 65e performs the following processing after S302. On the basis of the registration content of the pair list 24a, the extraction unit 65e extracts a second pair that has existed between a request and a response in a first pair whose request or response has existed between a request and a response in a given first pair (S401). In addition, the proceeding proceeds to S303.

As described above, the capture server 60 according to the present embodiment calculates the probability that the second pair exists between a request and a response in the first pair, and extracts a second pair corresponding to the given first pair on the basis of the calculated probability. In such a way as described above, on the basis of the probability, the capture server 60 according to the present embodiment extracts the second pair corresponding to the given first pair without using a model preliminarily defining pieces of information associated with each other. Accordingly, even if a correspondence between a new first pair and a new second pair occurs owing to the specification change of the system or the like, it may be possible for the capture server 60 according to the present embodiment to associate the new first pair and the new second pair with each other. Accordingly, according to the capture server 60 according to the present embodiment, it may be possible to more desirably associate pieces of relevant information with each other.

In addition, the capture server 60 according to the present embodiment acquires the logs of communication in the system including the first apparatus 11, the second apparatus 12, and the third apparatus 13. In addition, from among the acquired logs, the capture server 60 according to the present embodiment performs the following processing within a time range from a time when a request is transmitted from the first apparatus 11 to the second apparatus 12 to a time when a response corresponding to the request is transmitted from the second apparatus 12 to the first apparatus 11. Namely, the capture server 60 extracts a log indicating a pair of a request and a response, communicated between the second apparatus 12 and the third apparatus 13. For example, within a given time range within which a request and a response are communicated more than once, the capture server 60 according to the present embodiment calculates, with respect to each type, the probability that each of plural types of pairs of requests and responses, communicated between the second apparatus 12 and the third apparatus 13, has been communicated within a response time range of the request and response communicated more than once. In addition, with respect to a pair of a request and a response, communicated within a response time range relating to one of the request and response communicated more than once, the capture server 60 according to the present embodiment generates a plurality of combination patterns of the types of pairs of requests and responses. In addition, the capture server 60 according to the present embodiment selects one of the plural combination patterns on the basis of the degree of similarity with the calculated probability of each type. Accordingly, according to the capture server 60 according to the present embodiment, it may be possible to sequentially associate communication logs having a call relationship with each other, with respect to the acquired communication logs.

In addition, in addition to the probability or the like, furthermore, on the basis of the following information, the capture server 60 according to the present embodiment extracts a second pair corresponding to a given first pair. Namely, in the present embodiment, associating the first pair and the second pair with each other is performed on the basis of the combination of second pairs that have existed between a request and a response in a first pair whose request or response has existed between a request and a response in a given first pair. Namely, when such associating is performed, the combination of second pairs is considered that has existed between a request and a response in a first pair whose request or response has existed between a request and a response in a given first pair. Therefore, according to the capture server 60 according to the present embodiment, compared with a case in which such information is not considered, it may be possible to perform the associating with a higher degree of accuracy.

Incidentally, while the embodiments relating to the disclosed apparatus have so far been described, the present technology may be implemented in various different forms, in addition to the above-mentioned embodiments. Therefore, hereinafter, other embodiments included in the present technology will be described.

For example, individual apparatuses in the system to which the present technology is applied are not limited to the above-mentioned first apparatus to third apparatus, and the present technology is also applied to a system including a plurality of apparatuses.

In addition, from among the individual processing operations described in the second and third embodiments, all or part of a processing operation described to be automatically performed may also be manually performed. For example, the user or the like may input an execution instruction for each processing through an operation reception apparatus not illustrated.

In addition, in response to various kinds of loads or usage situations, it may be possible to arbitrarily subdivide or bring together processing operations in each processing described in each embodiment. In addition, it may also be possible to omit an operation. For example, it may also be possible to bring together S302 and S401, illustrated in FIG. 30.

In addition, in response to various kinds of loads or usage situations, it may be possible to change the order of processing operations in each processing described in each embodiment. For example, it may also be possible to interchange the order of S302 and S401 illustrated in FIG. 30.

In addition, each configuration element in each apparatus illustrated is a functional and conceptual element, and may not be physically configured as illustrated. Namely, the specific state of the distribution or integration of the individual apparatuses is not limited to one of examples illustrated in drawings, and all or part of the individual apparatuses may be functionally or physically integrated or distributed in arbitrary units according to various kinds of loads or usage situations. For example, the analysis unit 25a and the first detection unit 25b may be integrated, and it may be possible to configure a new first detection unit.

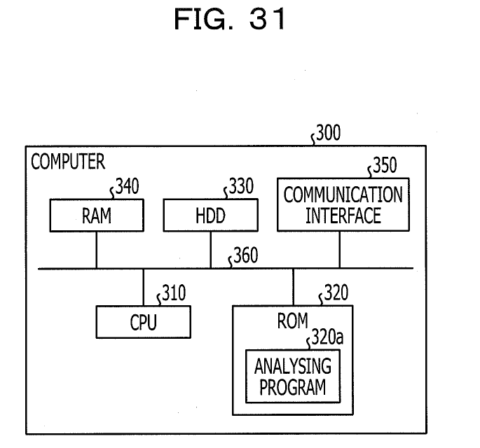

In addition, various kinds of processing operations of the analyzing apparatus or the capture server described in the above-mentioned embodiment may also be realized by executing a preliminarily prepared program in a computer system such as a personal computer, a workstation, or the like. Therefore, hereinafter, using FIG. 31, an example of a computer will be described that executes an analyzing program having the same function as that of the analyzing apparatus or the capture server, described in one of the above-mentioned first to third embodiments.

FIG. 31 is a diagram illustrating the computer executing the analyzing program. As illustrated in FIG. 31, a computer 300 in a fourth embodiment includes a central processing unit (CPU) 310, a read only memory (ROM) 320, a hard disk drive (HDD) 330, a random access memory (RAM) 340, and a communication interface 350. These individual units 300 to 350 are coupled to one another through a bus 360.

The communication interface 350 is used for acquiring the log of communication in the system including the first apparatus 11, the second apparatus 12, and the third apparatus 13. For example, the communication interface 350 is coupled to the port P4 of the above-mentioned switch 14. In this case, the communication interface 350 acquires, from the switch 14, the log of communication in the system including the first apparatus 11, the second apparatus 12, and the third apparatus 13.

In the ROM 320, a analyzing program 320a is preliminarily stored that fulfills the same functions as those of the analysis unit, the first detection unit, the second detection unit, the calculation unit, the extraction unit, and the annunciation control unit, illustrated in one of the above-mentioned first to third embodiments. In addition, the analyzing program 320a may also be arbitrarily separated. For example, the analyzing program 320a may also be separated into a program fulfilling the same functions as those of the analysis unit and the annunciation control unit and a program fulfilling the same functions as those of the first detection unit, the second detection unit, the calculation unit, and the extraction unit.

In addition, the CPU 310 is an example of a processor that reads out and executes the analyzing program 320a from the ROM 320. The processor is a hardware to carry out operations based on at least one program (such as the analyzing program) and control other hardware, such as the CPU 310, a GPU (Graphics Processing Unit), FPU (Floating point number Processing Unit) and DSP (Digital signal Processor).

In addition, in the HDD 330, a pair list, a first number-of-times table, a second number-of-times table, a degree table, a probability table, and a degree-of-importance table are provided. The pair list, the first number-of-times table, and the second number-of-times table correspond to the pair list 24a, the first number-of-times table 24b, and the second number-of-times table 24c, respectively. In addition, the degree table, the probability table, and the degree-of-importance table correspond to the degree table 24d, the probability table 24e, and the degree-of-importance table 24f, respectively.

In addition, the CPU 310 reads out and stores the pair list, the first number-of-times table, the second number-of-times table, the degree table, the probability table, and the degree-of-importance table in the RAM 340. Furthermore, the CPU 310 executes the analyzing program using the pair list, the first number-of-times table, the second number-of-times table, the degree table, the probability table, and the degree-of-importance table, stored in the RAM 340. In addition, all of individual pieces of data stored in the RAM 340 may not be continuously stored in the RAM 340, and a piece of data used for processing may be stored in the RAM 340, from among all of the individual pieces of data.

In addition, the above-mentioned analyzing program may not be caused to be stored in the ROM 320 from the beginning.

For example, the program is caused to be stored in a “portable physical medium” to be inserted into the computer 300, such as a flexible disk (FD), a CD-ROM, a DVD disk, a magneto-optical disk, an IC card, or the like. In addition, the computer 300 may also read out and execute the program from one of these media.

Furthermore, the program is caused to be stored in “another computer (or server)” coupled to the computer 300 through a public line, Internet, a LAN, a WAN, or the like. In addition, the computer 300 may also read out and execute the program from one of these.

In addition, each of the first apparatus 11, the second apparatus 12, the third apparatus 13, the client terminal 21, the Web server 22, and the DB server 23 may be an apparatus having the hardware configuration illustrated in FIG. 31. In that case, not only the analyzing program 320a but a desirable program may also be arbitrarily stored in the ROM 320 of each apparatus.

According to the above-mentioned embodiments, it may be possible to sequentially associate communication logs having a call relationship with each other, with respect to the acquired communication logs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An analyzing apparatus comprising:
a memory; and
a processor that executes a procedure, the procedure including:
controlling the memory to store logs of communication between a first apparatus and a second apparatus, and logs of communication between the second apparatus and a third apparatus; and
extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs stored in the memory.

2. The analyzing apparatus according to claim 1, wherein the procedure further includes:
calculating a plurality of appearance frequencies each of which correspond to a type of a pair including a request and a response corresponding to the request, communicated between the second apparatus and the third apparatus;
extracting groups each of which includes at least one pair among pairs of requests and responses, communicated within the time range between the second apparatus and the third apparatus;
calculating, with respect to each of the groups, a sum of the plurality of appearance frequencies other than appearance frequencies which are not correspond to the type of the pairs included in each of the groups; and
storing the pair of the second request and the second response associated with pairs included in a group corresponding to the sum which is larger than the sum of the other group, in the memory.

3. The analyzing apparatus according claim 2, wherein each of the plurality of appearance frequencies indicates appearance frequency of each type of pairs within time range from transmission of a past request which is same type as the second request, transmitted from the first apparatus to the second apparatus, to transmission of a past response corresponding to the past request, transmitted from the second apparatus to the first apparatus.

4. An analyzing apparatus comprising:
storing means for storing logs of communication between a first apparatus and a second apparatus, and logs of communication between the second apparatus and a third apparatus; and
extracting means for extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs stored in the storing means.

5. A computer-readable, non-transitory recording medium to store an analyzing program that causes a computer to execute a procedure, the procedure comprising:
acquiring logs of communication between a first apparatus and a second apparatus, and logs of communication between the second apparatus and a third apparatus; and
extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs acquired in the acquiring.

6. The recording medium according to claim 5, wherein the procedure further comprises:
calculating a plurality of appearance frequencies each of which correspond to a type of a pair including a request and a response corresponding to the request, communicated between the second apparatus and the third apparatus;
extracting groups each of which includes at least one pairs among pairs of requests and responses, communicated within the time range between the second apparatus and the third apparatus;
calculating, with respect to each of the groups, a sum of the plurality of appearance frequencies other than appearance frequencies which are not correspond to the type of the pairs included in each of the groups; and
associating the pair of the second request and the second response with pairs included in a group corresponding to the sum which is larger than the sum of the other group.

7. The recording medium according claim 6, wherein each of the plurality of appearance frequencies indicates appearance frequency of each type of pairs within time range from transmission of a past request which is same type as the second request, transmitted from the first apparatus to the second apparatus, to transmission of a past response corresponding to the past request, transmitted from the second apparatus to the first apparatus.

8. An analyzing method comprising:
acquiring logs of communication between a first apparatus and a second apparatus, and logs of communication between the second apparatus and a third apparatus; and
extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs acquired in the acquiring, by a processor.

9. The analyzing method according to claim 8, further comprising:
calculating a plurality of appearance frequencies each of which correspond to a type of a pair including a request and a response corresponding to the request, communicated between the second apparatus and the third apparatus;
extracting groups each of which includes at least one pairs among pairs of requests and responses, communicated within the time range between the second apparatus and the third apparatus;
calculating, with respect to each of the groups, a sum of the plurality of appearance frequencies other than appearance frequencies which are not correspond to the type of the pairs included in each of the groups; and
associating the pair of the second request and the second response with pairs included in a group corresponding to the sum which is larger than the sum of the other group.

10. The analyzing method according claim 9, wherein each of the plurality of appearance frequencies indicates appearance frequency of each type of pairs within time range from transmission of a past request which is same type as the second request, transmitted from the first apparatus to the second apparatus, to transmission of a past response corresponding to the past request, transmitted from the second apparatus to the first apparatus.

11. An analyzing system comprising:
a first apparatus;
a second apparatus;
a third apparatus; and
an analyzing apparatus that executes a procedure, the procedure including:
acquiring logs of communication between a first apparatus and a second apparatus, and logs of communication between the second apparatus and a third apparatus; and
extracting logs indicating a pair of a first request and a first response corresponding to the first request, communicated between the second apparatus and the third apparatus within a time range from transmission of a second request, transmitted from the first apparatus to the second apparatus, to transmission of a second response corresponding to the second request, transmitted from the second apparatus to the first apparatus, from among the logs acquired in the acquiring.
